(19) United States
(12) Patent Application Publication
(10) Pub. No.: US 2025/0103140 A1
(43) Pub. Date: Mar. 27, 2025

(54) AUDIO-HAPTIC CURSOR FOR ASSISTING WITH VIRTUAL OR REAL-WORLD OBJECT SELECTION IN EXTENDED-REALITY (XR) ENVIRONMENTS, AND SYSTEMS AND METHODS OF USE THEREOF

(71) Applicant: Meta Platforms Technologies, LLC, Menlo Park, CA (US)

(72) Inventors: Kashyap Todi, Seattle, WA (US); Tanya Renee Jonker, Seattle, WA (US); Hyun Sung Cho, Redmond, WA (US); Naveen Sendhilnathan, New York, NY (US); Tianyi Wang, Redmond, WA (US)

(21) Appl. No.: 18/896,727

(22) Filed: Sep. 25, 2024

Related U.S. Application Data
(60) Provisional application No. 63/585,139, filed on Sep. 25, 2023.

(51) Int. Cl. G06F 3/01; G06F 3/16

(52) U.S. Cl. CPC G06F 3/016; G06F 3/013; G06F 3/167

(57) ABSTRACT

A method for providing audio and haptic feedback to guide object selection while using an extended-reality device is disclosed. The method includes while a user is wearing an extended-reality headset that is associated with an output device, in accordance with a determination that a focus selector for the artificial-reality headset is directed to a first object with first visual characteristics, providing first haptic feedback and first audio feedback corresponding to the first visual characteristics via the output device. The method further includes in accordance with a determination that the focus selector for the artificial-reality headset is directed to a second object with second visual characteristics, distinct from the first visual characteristics, providing second haptic feedback and second audio feedback, distinct from the first haptic feedback and the first audio feedback, corresponding to the second visual characteristics via the output device.

### RELATED APPLICATIONS

This application claims the benefit of, and priority to, U.S. Provisional Patent Application Ser. No. 63/585,139, filed on Sep. 25, 2023, entitled “Audio-Haptic Cursor for Assisting with Virtual or Real-World Object Selection in Extended-Reality (XR) Environments, and Systems and Methods of Use Thereof,” which is incorporated by reference herein in its entirety.

### TECHNICAL FIELD

This relates generally to object selection in extended-reality environments, including but not limited to techniques for facilitating gaze-based object selection that relies on audio and haptic feedback.

### BACKGROUND

Extended realty (XR) presents new abilities to interact with the world. Object selection is one interaction in XR, which is used for targeting of real-world or virtual objects. Interaction techniques have been proposed to support fast and accurate object selection in spatial computing. Gaze-based selection techniques have gained attention as they support direct and hands-free selection. These input techniques have conventionally assumed the availability of situated, or world-overlaid, visual cues (e.g., gaze ray, cursor, highlight) to provide continuous feedback on the current selection to the user.

However, accurate visual feedback will not always be feasible in XR systems. First, this is evident in no-display smart glasses, or glasses with small head-anchored displays. Without a full display, it is either difficult to provide any directly visible feedback on the glasses, or the visual feedback cannot be directly overlaid on objects in the world. This leads to a lack of visual feedback or inaccurately aligned visual feedback and object selection errors arise. Even with the possibility of future full-display XR glasses or headsets, effective non-visual feedback could be beneficial to either replace or augment visual feedback. As such, there is a need for non-visual feedback during object selection in XR.

As such, there is a need to address one or more of the above-identified challenges. A brief summary of solutions to the issues noted above are described below.

### SUMMARY

The methods and systems disclosed herein describe an audio-haptic system for gaze-based object selection that relies (including solely) on audio and haptic feedback. As a user's gaze hovers over objects in extended-reality (XR) environments, the audio-haptic system provides audio and haptic feedback that uniquely represents each object. This generates a global feedback that is unique to each object and local feedback that amplifies differences between closely located objects. To generate this feedback, cross-modal correspondences in human perception are leveraged, where certain properties can be perceived by multiple sensory modalities. The audio-haptic system utilizes cross-modal mappings of visual features (e.g., color, saturation, brightness, contrast, position, size, material, etc.) to audio and haptic properties. The audio-haptic properties can be selected from a group including audio pitch, audio direction, audio amplitude, audio timbre, haptic intensity, haptic rhythm, haptic frequency, haptic duration, etc. For example, four visual features are utilized to generate four cross-modal mappings to the audio-haptic properties. The cross-modal mappings of visual features to the haptic properties cause variations in haptic feedback associated with intensity, duration, frequency, directionality, and/or rhythm to generate varying tactile and/or force-feedback vibrations through a sense of touch. For example, the visual feature of object size correlate with haptic intensity. As another example, the visual feature of object color saturation (or lightness) correlates with audio pitch.
(A1) In accordance with some embodiments, a method of providing audio and haptic feedback to guide object selection while using an extended-reality device is disclosed. The method includes while a user is wearing an artificial-reality headset that is associated with an output device: (i) at a first point in time, in accordance with a determination that a focus selector for the artificial-reality headset is directed to a first object with first visual characteristics, providing first haptic feedback and first audio feedback corresponding to the first visual characteristics via the output device, and (ii) at a second point in time that is after the first point in time, in accordance with a determination that the focus selector for the artificial-reality headset is directed to a second object with second visual characteristics, distinct from the first visual characteristics, providing second haptic feedback and second audio feedback, distinct from the first haptic feedback and the first audio feedback, respectively, corresponding to the second visual characteristics via the output device. As shown in FIG. 1, the user's gaze is hovering over a TV and a white vase that are present close to each other within the user's field-of-view (FOV). The audio-haptic system processes the user's gaze to provide a global feedback if the user's gaze is determined to be hovering over the TV. For example, the global feedback for the TV can correspond to a strong haptic vibration indicative of a relatively large object size and a low-pitch audio indicative of the TV's dark color. In some embodiments, the low-pitch audio is accompanied by a metallic timbre to indicate the TV's dark color. The audio-haptic system processes the user's gaze to provide different audio-haptic feedback, distinct from the global feedback for the TV, if the user's gaze is determined to be hovering over the smaller white vase. For example, the audio-haptic system causes the generation of a weak haptic vibration indicative of the smaller size of the white vase and a high-pitch audio indicative of the white color of the vase. In some embodiments, the high-pitch audio is accompanied by a ceramic timbre indicative of the white color of the vase to provide more distinctive audio-haptic feedback.
(A2) In some embodiments of A1, the method further includes at a third point in time that is after the first point in time and after the second point in time, in accordance with a determination that the focus selector for the artificial-reality headset is directed to a third object with third visual characteristics, distinct from the first and second visual characteristics, providing third haptic feedback and third audio feedback, the third haptic feedback being distinct from the first and second haptic feedback and the third audio feedback being distinct from the first and second audio feedback, corresponding to the third visual characteristics via the output device. FIG. 1 illustrates two examples of items the user is looking at but as the user looks around the room at different objects, the focus selector also moves and provides the user with audio and haptic feedback based on the characteristics of additional objects the user is looking at.
(A3) In some embodiments of A1, the first and second visual characteristics include object material, object position, object color lightness, object size, saturation, brightness, contrast, etc. The method further includes each of the first haptic feedback and the second audio feedback is provided using respective values for audio timbre, audio direction, and audio pitch. The method also includes each of the first haptic feedback and the second haptic feedback is provided using respective values for haptic intensity, wherein respective values for audio timbre are selected based on object material, respective values for audio direction are selected based on object position, respective values for audio pitch are selected based on object color and/or lightness, and respective values for haptic intensity are selected based on object size.
(A4) In some embodiments of A1, the focus selector is a gaze-based cursor. FIG. 1 illustrates the eyes on the user's head intended to illustrate that the user is looking at the TV and white vase.
(A5) In some embodiments of A1, the output device is one of: a wrist-wearable device, a head-wearable device, or a wearable glove. FIG. 3 illustrates the output device as a hand-held controller and a wrist wearable device.
(A6) In some embodiments of A1, the artificial-reality device is an artificial-reality headset that does not include a display. As discussed with respect to FIGS. 22A-22C and illustrated in FIG. 1, the user can wear an artificial-reality headset that has a limited display or no display at all.
(A7) In some embodiments of A1, the first haptic feedback and the first audio feedback are provided by different devices (e.g., by combinations of the output device and the artificial-reality device). As illustrated in FIGS. 1 and 3, audio can be provided by headphones and haptic feedback can be provided by a hand-held controller and/or a wrist-wearable device. The hand-held controller illustrated in FIG. 3 can also produce audio feedback.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

FIG. 1 illustrates an example of an audio-haptic cursor for XR generating unique audio and vibrotactile cues as a user's gaze hovers over 3D objects, in accordance with some embodiments.

FIG. 2 illustrates an example of the “bouba/kiki” effect, in accordance with some embodiments.

FIG. 3 illustrates an example of a setup for perception optimizations, in accordance with some embodiments.

FIGS. 4A and 4B illustrate an example of one-to-one mappings of object color lightness to audio pitch and to haptic intensity, in accordance with some embodiments.

FIGS. 5A and 5B illustrate an example of compound mappings of object color lightness to audio pitch and to haptic intensity, in accordance with some embodiments.

FIGS. 6A and 6B illustrate an example of one-to-one mappings of object size to audio pitch and to haptic intensity, in accordance with some embodiments.

FIGS. 7A and 7B illustrate an example of compound mappings of object size to audio pitch and to haptic intensity, in accordance with some embodiments.

FIG. 8 illustrates an example of Pearson's correlation coefficients for object color lightness/object size to audio pitch/vibration amplitude mappings, in accordance with some embodiments.

FIGS. 9A and 9B illustrate two charts showing polynomial regression models for audio pitch versus object color lightness and for vibration amplitude versus object size, in accordance with some embodiments.

FIG. 10 shows example illustrations comparing the audio-haptic system to four different feedback scenarios, in accordance with some embodiments.

FIG. 11 shows example illustrations of three user gaze evaluation sessions used for comparing each of the five feedback techniques to select a given target, in accordance with some embodiments.

FIG. 12 illustrates a chart showing the average target selection time for each feedback technique, in accordance with some embodiments.

FIGS. 13A and 13B illustrate a chart and a table showing target selection time over trials in three splits, in accordance with some embodiments.

FIGS. 14A and 14B illustrate two charts showing average error rate for each feedback technique and accuracy for each feedback technique, in accordance with some embodiments.

FIG. 15 illustrates a table that shows respective error rates corresponding to number of distractor objects near the target object for each feedback technique, in accordance with some embodiments.

FIG. 16 illustrates a table that shows error rate by object size for each feedback technique, in accordance with some embodiments.

FIG. 17 illustrates a table that shows object descriptions, their materials, and what scene they are used in, in accordance with some embodiments.

FIG. 18 illustrates another table that shows object descriptions, associated materials, and what scenes they are used in, in accordance with some embodiments.

FIG. 19 is a flow diagram illustrating an example audio-haptic feedback method for object selection in extended-reality, in accordance with some embodiments.

FIGS. 20A, 20B, 20C-1, and 20C-2 illustrate example artificial-reality systems, in accordance with some embodiments.

FIGS. 21A and 21B illustrate an example wrist-wearable device 2000, in accordance with some embodiments.

FIGS. 22A, 22B-1, 22B-2, and 22C illustrate example head-wearable devices, in accordance with some embodiments.

FIGS. 23A and 23B illustrate an example handheld intermediary processing device, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

The audio-haptic system is a feedback system for object targeting in XR; one that does not rely primarily on the visual modality. Current visual feedback systems for XR require world-locked displays that can perfectly align and overlay visual cues (e.g., a cursor) onto the real world, making them unusable in display-free and head-anchored AR glasses. The audio-haptic system makes use of non-visual modalities to deliver cursor feedback, alleviating hardware limitations and ensuring usability by using cross-modal correspondences in human perception. This enables the representation of visual object features with alternative modalities such as audio and haptics. The audio-haptic system described herein includes methods and systems that achieve improved performance for generating entirely non-visual feedback for object selection in XR. In some embodiments, the improved performance is from instantaneous feedback, minimal hardware requirements, object scalability, and scene generalizability.

In some embodiments, as users target at objects, continuous and instantaneous audio-haptic feedback ensures speed and accuracy, and eliminates the need for error correction.

In some embodiments, the audio-haptic feedback mechanism is applicable to XR devices with varying, often limited, hardware capabilities. This is achieved by making use of spatial audio, readily available via headphones or glass-mounted speakers, and haptic actuation on the wrist using low-cost linear resonance actuators ensuring minimal hardware resources.

In some embodiments, the audio-haptic system is applicable to an extensive set of objects without requiring instrumentation or manual training ensuring object scalability. Visual features such as size, color, and material are used, which can be distinguished by world-facing cameras using off-the-shelf computer vision models.

In some embodiments, the cursor is usable in scenes and environments that vary in complexity (e.g., varying number of objects, objects placed at arbitrary 3D positions, and objects surrounded by varying clutter, etc.) ensuring scene generalizability. For example, the audio-haptic system generates feedback that includes unique cues that can address such complexities. Further, the interaction technique can support feedback with varying granularities.

Embodiments of this disclosure can include or be implemented in conjunction with distinct types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application, the term “extended reality (XR)” is used as a catchall term to cover both ARs and MRs. In addition, this application also uses, at times, a head-wearable device or headset device as a catchall term that covers XR headsets such as AR headsets and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device)) or a combination of the user's hands. “In-air” means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

The methods and devices described herein include methods and systems for producing an audio-haptic cursor for extended-reality (XR) object selection. The audio-haptic system addresses challenges around providing accurate visual feedback during gaze-based selection in XR, e.g., lack of world-locked displays in no- or limited-display smart glasses and visual consistencies. To enable users to distinguish objects without visual feedback (or with only limited visual feedback), the audio-haptic system employs cross-modal correspondence in human perception to map visual features of objects (e.g., color, saturation, brightness, position, size, material, etc.) to audio-haptic properties (e.g., pitch, direction, amplitude, timbre, haptic intensity, haptic amplitude, etc.). Data-driven models are used for determining cross-modal mappings of visual features to audio and haptic features, and a computational approach to automatically generate audio-haptic feedback for objects in the user's environment. The audio-haptic system provides global feedback that is unique to each object in the scene, and local feedback to amplify differences between nearby objects. The comparative evaluation shows that the audio-haptic system enables accurate object identification and selection in a cluttered scene without visual feedback.

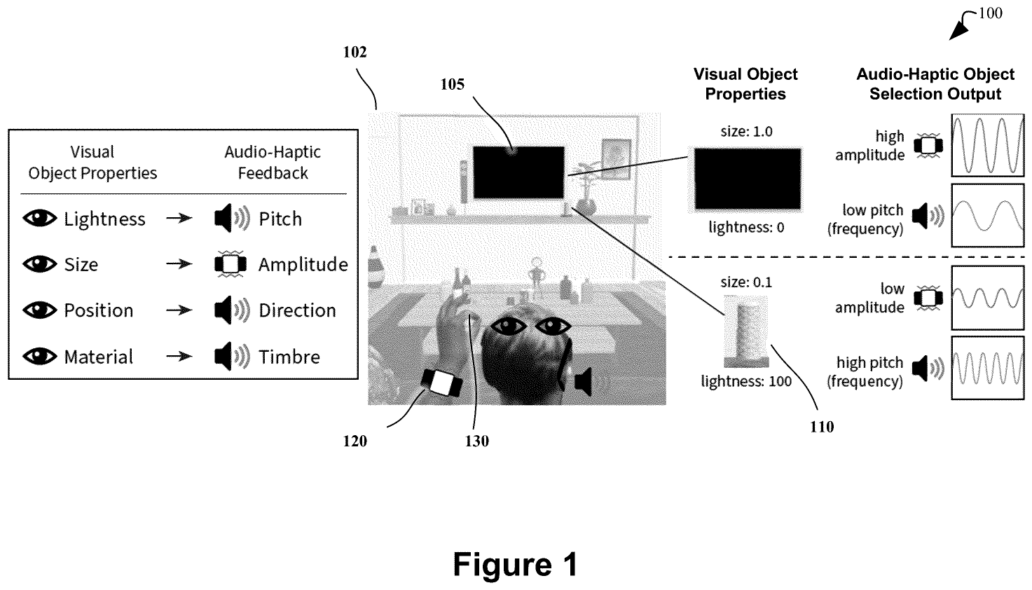

FIG. 1 illustrates an example audio-haptic system for XR selection of a first object out of a group of objects in the user's field-of-view (FOV) 102. For example, a user is wearing display-free AR glasses and a haptic wristband 120. The user's gaze hovers over the black TV 105 while the audio-haptic system is activated, and the audio-haptic system plays audio-haptic feedback to inform the user that the TV 105 is “selected” by the system. In some embodiments, the audio-haptic system generates a strong vibration with low-pitch audio respectively corresponding to the large size and dark color of the TV 105. The small white vase 110 next to the TV 105, in contrast, causes the audio-haptic system to generate weak wristband haptic vibration and high-pitch audio. The distinct audio-haptic feedback corresponding to the visual characteristics of the targeted objects (e.g., the large black TV 105, small white vase 110, etc.) helps users identify which object is selected as the target by the system despite small- or no-display AR glasses. For objects with more similar properties, the user can optionally switch to a local feedback mode which amplifies the differences among nearby objects for enhanced disambiguation. For objects that are fairly dissimilar, a global feedback mode of the audio-haptic system can remain active and generate a standard audio-haptic response, with no amplification of audio and/or haptic feedback needed.

For example, the TV 105 is the largest object in the user's FOV and is black-colored. The audio-haptic system generates high-amplitude haptics (e.g., vibrations) on the user's wristband reflecting the large object size and low-pitch audio with metallic timbre via in-built speakers or earphones of a wearable device, reflecting the object's dark color. In contrast, the audio-haptic system processes the visual properties of the small white vase 110 to generate low-amplitude haptics (e.g., vibrations) reflecting the small object size and high-pitch audio with a ceramic timbre, reflecting the object's white color.

The audio-haptic system utilizes at least four cross-modal mappings of visual object features and/or visual object characteristics (e.g., color lightness, position, size, material, etc.) to audio and haptic properties (e.g., pitch, direction, amplitude, timbre, etc.). To systematically understand and develop cross-modal mappings for color lightness and size, a perceptual matching study was conducted with 28 participants and collected data on how people map different levels of visual properties (color lightness and size) to audio-haptic properties (audio pitch and haptic intensity). Through the study, high positive correlations between color lightness and audio pitch, and between size and haptic intensity were found. For example, users associate lighter-colored objects with higher-pitch sounds, and larger objects with stronger vibration. Leveraging this data, data-driven computational models were contributed to map color lightness to audio pitch, and size to haptic intensity for the audio-haptic system. Additionally, in some embodiments, the audio-haptic system maps object position to sound source direction using spatial audio, and represents material using audio timbre by prompting a text-to-audio generative latent diffusion model to generate the sound produced on collision with an object of the given material.

The audio-haptic system uses these cross-modal mappings to automatically generate audio-haptic feedback for each object in a given scene. The cross-model mappings are tailored to provide global feedback signatures unique to each object in the scene, and local feedback signatures that amplify differences between closely located objects. The global feedback and local feedback can be used together to distinguish and identify objects even with limited or no visual display in complex, cluttered scenes.

To evaluate the audio-haptic system, a user study was conducted with 20 participants. The performance of the audio-haptic system was compared to other non-visual and visual feedback techniques (no feedback, static directional audio, text-to-speech descriptions, and visual indicator) in a gaze-based 3D target selection task. Results show that the audio-haptic system enables accurate selection compared to other non-visual feedback, and enables a more intelligent and interactive feedback mechanism for object selection. For example, audio-haptic feedback is automatically generated as users hover their gaze over objects and users can switch between global feedback, for all objects in the scene, or locally amplified feedback for a nearby set of objects.

In some embodiments, the audio-haptic system determines cross-modal correspondences in human perception to generate unique audio-haptic feedback signature that respectively corresponds to each object within a user's FOV. As one example, beyond replicating realistic haptic and audio effects, the audio-haptic system encodes an object's visual information into audio-haptic feedback for object identification, leveraging cross-modal correspondence. The audio-haptic system can generate audio-haptic feedback to enhance selection accuracy in no- or limited-display AR glasses with improved contextual user interactions.

For example, the audio-haptic system can enable a user wearing smart glasses, with world-facing cameras and eye tracking capabilities, to enter a living room (e.g., as illustrated in FIG. 1) and turn On the TV 105 based on audio-haptics enhanced user gaze perception. The user can hold an in-air pinch gesture 130 to activate gaze-based selection using the audio-haptic system and activate real-time audio-haptic feedback as the user's gaze crosses registered objects in the room. The user can look at the TV 105, perceive the corresponding feedback (e.g., strong vibration and low-pitch metallic timbre), and confirm that the target is correctly anchored on the TV 105. By releasing the in-air pinch gesture 130, the user can now trigger the action of turning on the TV 105. The in-air pinch gesture can also trigger other related actions using alternate hand gestures, such as finger-swiping for volume control.

In another example embodiment that includes in-world queries, all-day wearable XR glasses offer additional possibilities of instantly querying objects and artifacts in the real world to gain more information about them. For example, a user's device for a user running errands in a supermarket provide an app that analyzes a product and verifies whether it meet pre-defined dietary preferences (e.g., gluten-free, low-calories, etc.). When buying noodles, the user then initiates object selection with the audio-haptic system via a short tap on the stem of the XR glasses. The XR glasses configured with the audio-haptic system will generate corresponding audio-haptic feedback if the user's gaze hovers over a small, dark-colored pack of rice noodles (e.g., low-pitched audio, low haptic intensity), enabling the user to distinguish it from the large bag of wheat noodles (e.g., triggers high haptic intensity) next to the small, dark-colored pack of rice noodles. The user selects the targeted product with a pinch gesture to query the app, which then inform the user that the selected pack of noodles meets the user's pre-defined dietary needs. In some embodiments, the user can complete the selection of the small pack of rice noodles based on gaze and voice commands, which synchronize with the audio-haptic feedback, in case the user's hands were encumbered with another activity.

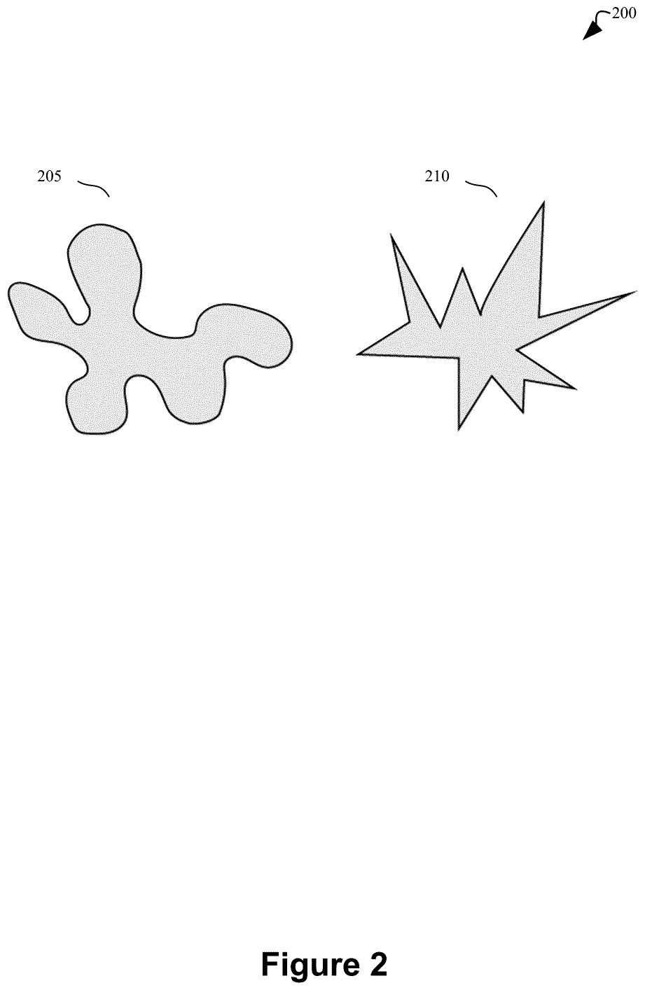

FIG. 2 illustrates the “bouba/kiki” effect which is an example of cross-modal correspondence. Cross-modal correspondence is the tendency to associate stimulus features across different sensory modalities (e.g., shapes visually or aurally). When visually presented with two arbitrary 2D shapes, one round shape 205 and one angular, jagged shape 210 and two names “bouba” and “kiki”, a majority of people tend to associate the round shape to the name “bouba” and the jagged one to “kiki.”

For example, in some embodiments, people can associate high pitch sounds with light colors, higher pitch and lower intensity sounds to smaller size, louder sound to longer size, and higher pitch to higher vertical location. As described in various embodiments herein, the audio-haptic system leverages this perception-level correspondence across modalities to design audio-haptic representations of visual objects that can be perceived fast and accurately in the cursor interaction.

In some embodiments, visual object properties include color, size, shape, material, and/or position. In some embodiments, the audio-haptic system generates one-to-many mappings, where each object visual property is mapped to multiple audio and vibrotactile properties. For example, pitch (frequency), amplitude, timbre/wave types (sine, square, sawtooth, triangle waves), and duration can be mapped to audio properties; and frequency, amplitude, haptic pattern, and duration can be mapped to haptic properties. Too high of a number of mappings can induce significant cognitive burden in decoding information without providing large accuracy gains.

The perceivability of differences in the property were taken into consideration, redundancy or overlaps between properties, invariance to environmental noise, and impact on user experience, which are important factors in context-aware XR systems. For example, variance in audio amplitude was hard to perceive in a noisy environment; distinguishing changes in haptic frequency vs. haptic amplitude simultaneously was hard; high haptic frequency overlapped with audio; square, sawtooth, and triangle waves felt uncomfortable to some people; and position is already represented through spatial audio in XR. Through this elimination process, a concrete feature space was derived for further investigation: material, color lightness, and size as key visual properties; timbre and pitch for audio; and amplitude for haptics.

In some embodiments, the audio-haptic system represents at least four unique visually-perceivable features using audio and haptic properties to computationally generate non-visual feedback for any object in a given scene. Naturalistic mappings were adopted for representing material and position that simulate realistic impact sound.

In some embodiments, object material is mapped to audio timbre. For example, seven representative materials were selected that commonly compose everyday objects: ceramic, glass, plastic, metal, wood, fabric, and paper. The impact response sound was generated for each material using a text-to-audio generative AI model. The prompts included “A short impact sound . . . ”: “of two metal objects colliding”, “when a cushion is dropped on a soft bed”, “when a fork hits a ceramic object”, and so on for each material. This approach can generalize to other materials as needed.

In some embodiments, object position is mapped to audio direction The audio-haptic system spatializes audio in the left-right direction based on the angle between the object location and the head gaze.

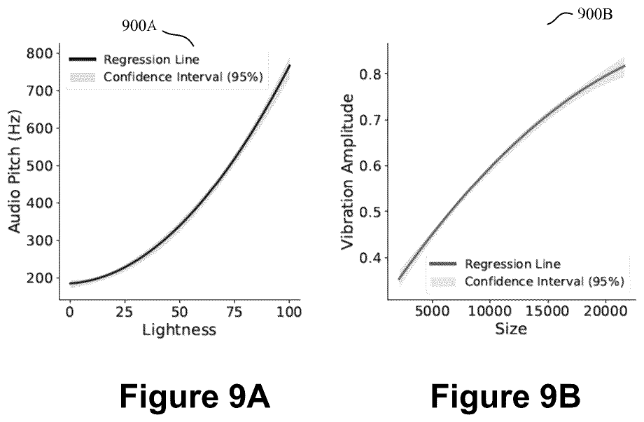

In some embodiments, object color lightness is mapped to audio pitch. Lightness levels are split using the CIELAB color space, which is known to be perceptually uniform. It has been evidence that there is a direct mapping between color lightness and pitch (i.e., lighter objects are perceived to have higher pitch values). However, they do not provide a systematic value mapping. A regression model was developed (FIG. 9A) and applied to predict pitch value given the color lightness level of an object. A detailed description of the perception study and resulting model is provided below.

In some embodiments, object size is mapped to haptic intensity. Larger objects are mapped to higher haptic intensities. For example, the haptic intensities are generated using haptic actuators installed in wearable devices. A regression model was developed (as described in FIG. 9B) and applied to predict haptic intensity amplitude values given the size of any object.

In accordance with some embodiments, during selection tasks, the cross-model optimized audio-haptic system provides instantaneous feedback for each object in the XR environment. The feedback mechanism is generalizable to varying device specification. By default, global feedback is generated by identifying visual properties of an object and applying the cross-modal mappings. Consequently, unique audio-haptic feedback can be perceived for each visible object.

However, when similar objects are close by, or a region is cluttered with several objects, the provided feedback might not be sufficiently distinctive to support accurate disambiguation. In some embodiments, the audio-haptic system includes a local amplification approach, where differences in feedback for nearby objects is accentuated. In some embodiments, the local amplification can be an interactive mode, which can be invoked by the user. Additionally, or alternatively, the system automatically triggers activation of the local amplification mode when detecting a threshold level of clutter in a scene.

In some embodiments, the audio-haptic system only considers objects that are within a selection sphere (e.g., a sphere of radius r) around the last-gazed object and/or ranks them by color lightness and/or size. For example, objects characterized by a dark color and large size are ranked higher than objects characterized by a light color and small size. In some embodiments, the audio-haptic feedback generated by the audio-haptic system directly correlates with the ranking of the objects within the selection sphere. For example, the higher the rank assigned to an object, the greater the audio and/or haptic feedback intensity. As another example, the greater the similarity in the visual characteristics and the closer the assigned ranks for a group of objects within the selection sphere, the greater is the probability for triggering the local amplification mode of the audio-haptic system for improving disambiguation in object selection.

In some embodiments, the radius of the selection sphere is determined based on a distance of the cluttered objects from the extended-reality device providing the audio-haptic system. For example, the greater the distance away the objects are, the larger is the radius r and the closer the objects, the smaller is the radius r. Alternatively, in some embodiments, the greater the distance away the objects are, the smaller is the radius r. In some embodiments, the radius r can depend on various factors including a position and/or specification(s) of one or more point-of-view cameras associated with the extended-reality device, user settings associated with a user's visual needs, ambient lightning conditions, one or more predetermined settings associated with the extended-reality device performance, interface device specifications, etc.

In some embodiments, the objects within the sphere of radius r around the last-gazed object are ranked based on one or more additional visual characteristics including material, position, brightness, transparency, chromaticity, etc. In some embodiments, objects with similar material properties are ranked based on an analysis of the respective material property in respectively corresponding sets. In some embodiments, objects with similar visual characteristics are ranked in corresponding sets that respectively correspond to at least one visual characteristic of the objects. For example, objects with similar color lightness are assigned to a first set of visual characteristics respectively associated with the color lightness. For example, objects with the material properties of wood are assigned to a second set of visual characteristics that have the same material properties of wood. In some embodiments, the visual characteristics are part of a hierarchical object classification system for ease of object ranking. In some embodiments, color lightness can rank higher than material. For example, objects with a lighter color are assigned a higher rank than objects of a darker color although the objects are associated with wood.

Following the ranking, in some embodiments, the audio-haptic system can distribute and/or assign audio pitch and/or vibration amplitude, thus ensuring that feedback for each object is sufficiently different. For example, the system assigns an object made of a wooden material a low vibration amplitude and assigns a nearby object made of stainless steel a high vibration amplitude. In some embodiments, the distribution and/or assignment of audio pitch and vibration amplitude can be uniform. In some embodiments, the distribution and/or assignment of audio pitch and vibration amplitude can include sufficient diversity to enable a user to differentiate between objects within a subset of a set of visual characteristics.

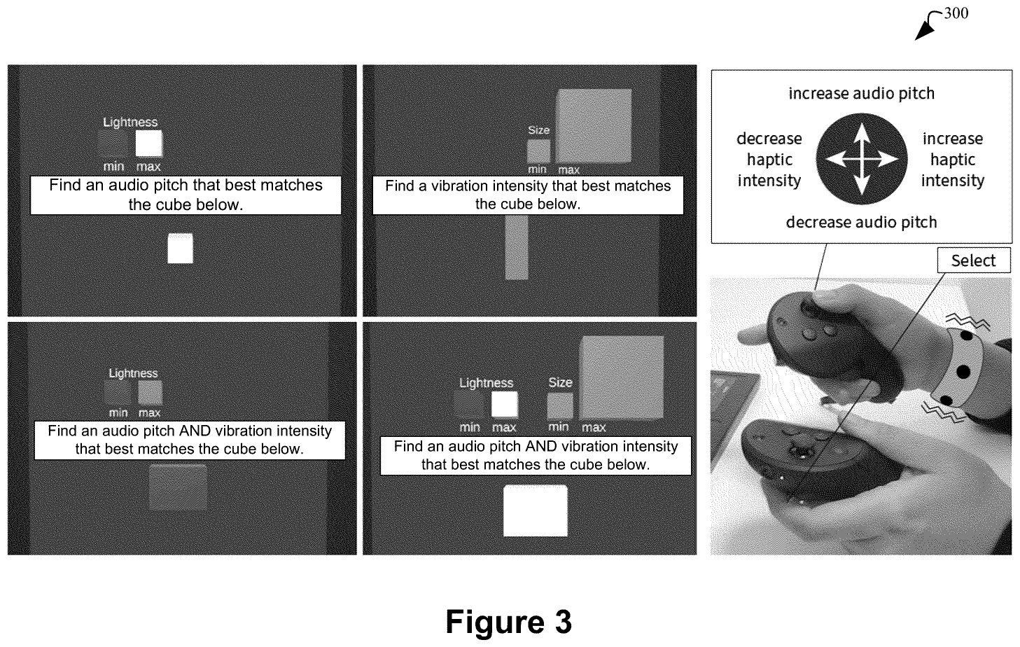

FIG. 3 illustrates a perception study setup to investigate how people perceive the cross-modal correspondences in a controlled setup, in accordance with some embodiments. Participants were shown a cube that varied in color lightness and size. In some embodiments, participants used a handheld controller to manipulate the pitch of an audio signal (left-right direction) and intensity of a vibration signal (up-down), and the left controller trigger button to confirm selection after selecting the best matching pitch and signal. In-ear stereo earphones were used for audio feedback. Four linear resonance actuators positioned at cardinal directions on a wristband provided haptic feedback.

In the perception study, participants were presented with objects with varying visual features as stimulus. Response data was collected for audio and haptic properties towards constructing models that capture reliable mappings. Among cross-modal correspondences, properties were selected that are generalizable to a large set of visual objects and applicable to extended-reality usage context. As described above, audio-haptic properties that are prone to environmental noise or challenging to perceive, such as audio intensity, were excluded. For the visual modality, the color lightness and size were chosen as independent variables; for auditory and haptic modalities, audio pitch and vibrotactile intensity were chosen as dependent variables.

Color lightness and size were selected as key independent variables used to generate a stimulus. Color Lightness: The L (lightness) axis was used of CIELAB color space. This axis is designed to be perceptually uniform, which means a given numerical change corresponds linearly to a similar perceived change in color. Five levels (L=0, 25, 50, 75, 100) of color lightness were sampled. Both grayscale and colored versions of color lightness were investigated. In the grayscale version, a=0 and b=0 in the CIELAB space. For the colored version, 8 combinations were sampled of a=−128, 0, 128 and b=−128, 0, 128, excluding the grayscale (a=0, b=0). Size: Object size is varied in two dimensions, width, and height. Four levels were assigned as the width and height values, determined by size perception, resulting in 10 different area sizes of 16 different shapes, {(w, h)|w, h ∈{46, 83, 116, 147}}.

In some embodiments, for the dependent variables, participants specified audio pitch and/or haptic intensity in response to each stimulus. These below are referred to as pitch and intensity for simplicity. Pitch ranged across 36 frequencies corresponding to the note C3 (130.81 Hz) to B5 (987.77 Hz) on a piano scale. Discrete notes were chosen on the scale to avoid dissonance and ensured constant audio amplitude. Intensity varied on a continuous range from 0.125 to 1.0, with uniform vibration amplitude applied over four evenly-distributed actuators on a wristband.

The study consisted of six one-to-one mapping conditions, (lightness in grayscale, lightness in color, size)×(pitch, intensity). For each condition, only one independent variable changed, and participants were asked to specify the corresponding value for only one dependent variable. In these one-to-one mapping conditions, each level of the independent variable appeared 10 times (5 lightness levels×10 repetitions, 10 area sizes×10 repetitions). To test if mappings persist or confound when variables are compounded, data was also collected for two-to-two mapping condition, where both lightness (grayscale) and size varied at the same time (5 lightness levels×10 area sizes×8 trials), and participants specified both pitch and intensity simultaneously. Participants completed all conditions in a within-subject study design.

In each trial, participants were presented with a cube/cuboid of varying color and/or size, depending on the condition, as stimulus. Participants were asked to identify a pitch and/or intensity that best corresponded to the cube (e.g., as illustrated in FIG. 3). The participants used the 2D thumbstick on the right controller to control the pitch (up and down) and intensity (left and right). A pulse wave signal was repeatedly played for the corresponding channel to indicate the change in the pitch and intensity. To cover all conditions, the study consisted of a total of 900 trials per participant. To prevent fatigue, participants were forced to take a short break after each condition as long as they wish. During the longest two-to-two mapping session, a minimum 8-second break was enforced and asked if they want a longer break after every 50 trials. At any point during the study, participants could take breaks as needed.

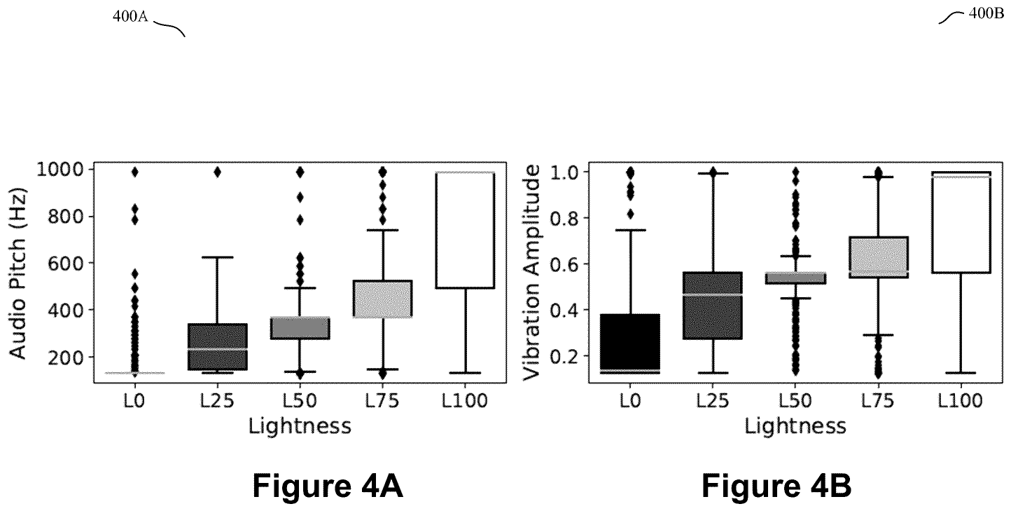

FIGS. 4A and 4B illustrate one-to-one mappings of color lightness to audio pitch (r=0.709) (e.g., FIG. 4A) and color lightness to vibration amplitude (r=0.514) (e.g., FIG. 4B). In both FIGS. 4A and 4B, the x-axis shows the color lightness level in CIELAB color space (L0=black, L100=white). In FIG. 4A, the y-axis represents the pitch in Hz. In FIG. 4B the y-axis represents the vibration amplitude or vibration intensity. One-to-one mappings are when participants could change only one of pitch and intensity value at a time when only one of color lightness or size changed.

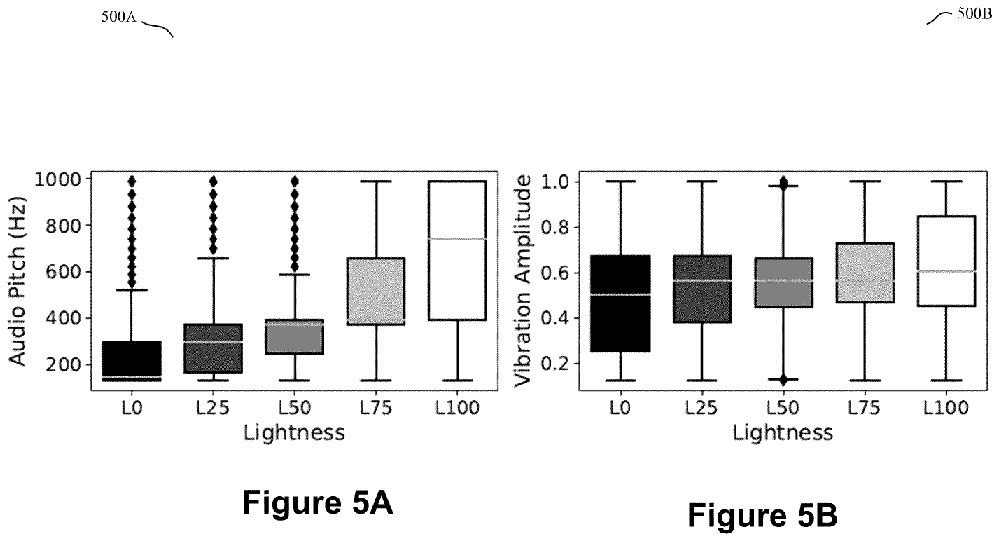

FIGS. 5A and 5B illustrate compound mappings of color lightness to audio pitch (r=0.530) (e.g., FIG. 5A) and color lightness to vibration amplitude (r=0.173) (e.g., FIG. 5B). In both FIGS. 5A and 5B, the x-axis shows the color lightness level in CIELAB color space (L0=black, L100=white). In FIG. 5A, the y-axis represents the pitch in Hz. In FIG. 5B the y-axis represents the vibration amplitude or intensity. Compound mappings are when participants could change both pitch and intensity values at once while both color lightness and size of the cube change simultaneously.

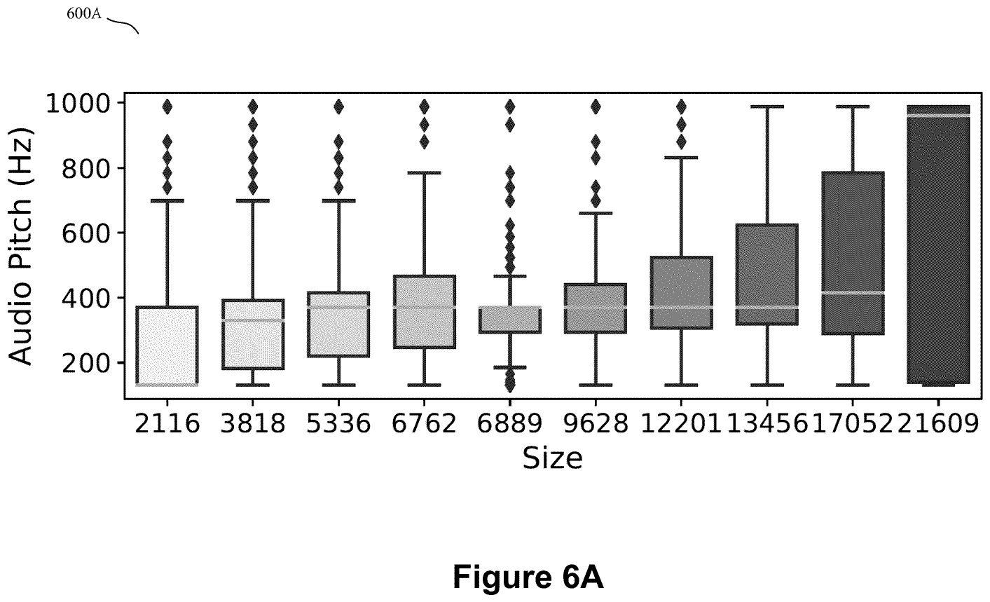

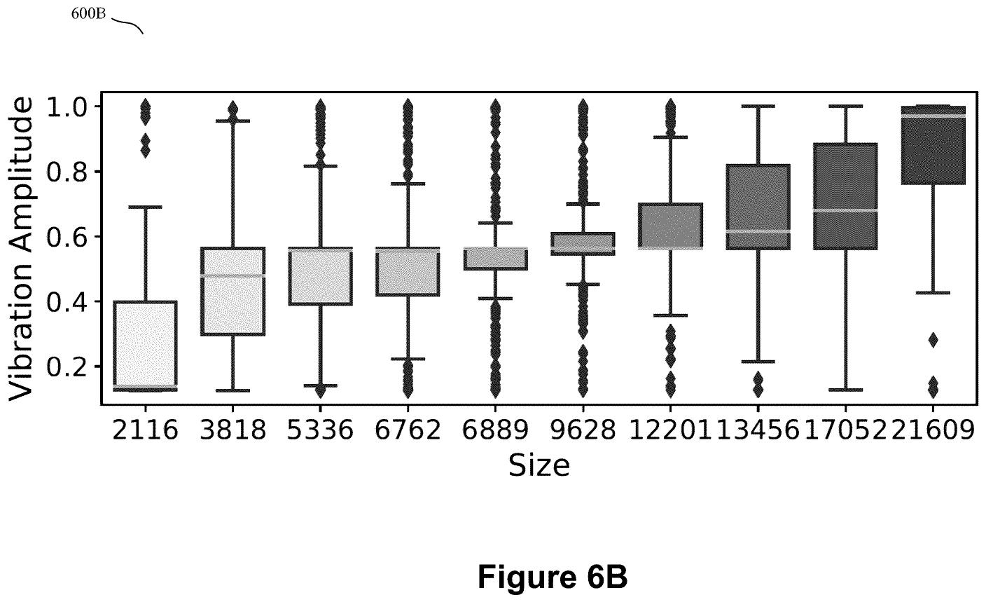

FIGS. 6A and 6B illustrate one-to-one mappings of object size to audio pitch (r=0.311) (e.g., FIG. 6A) and object size to intensity (r=0.567) (e.g., FIG. 6B). In both FIGS. 6A and 6B, the x-axis shows the area size of the cube from small to large. In FIG. 6A, the y-axis represents the pitch in Hz. In FIG. 6B the y-axis represents the intensity.

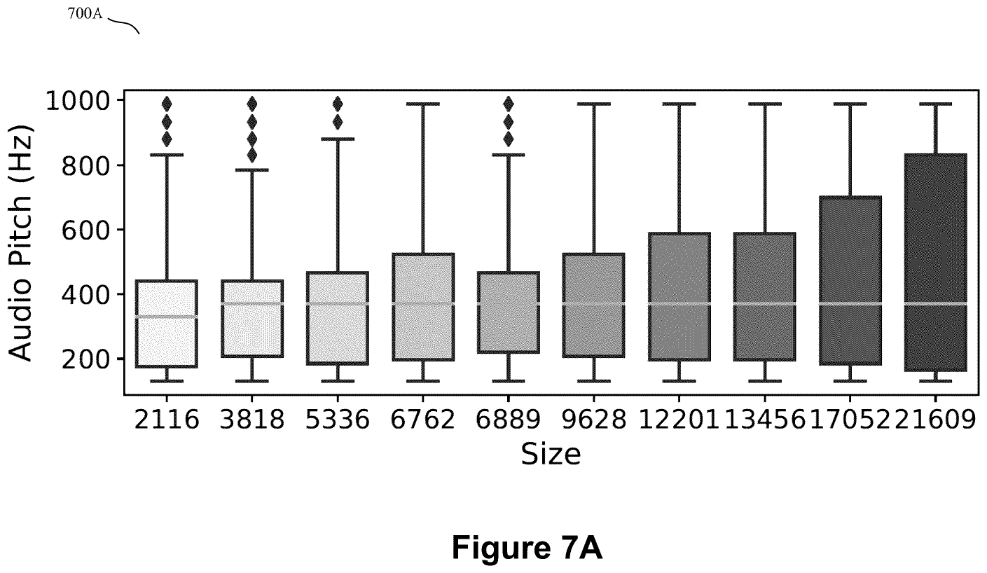

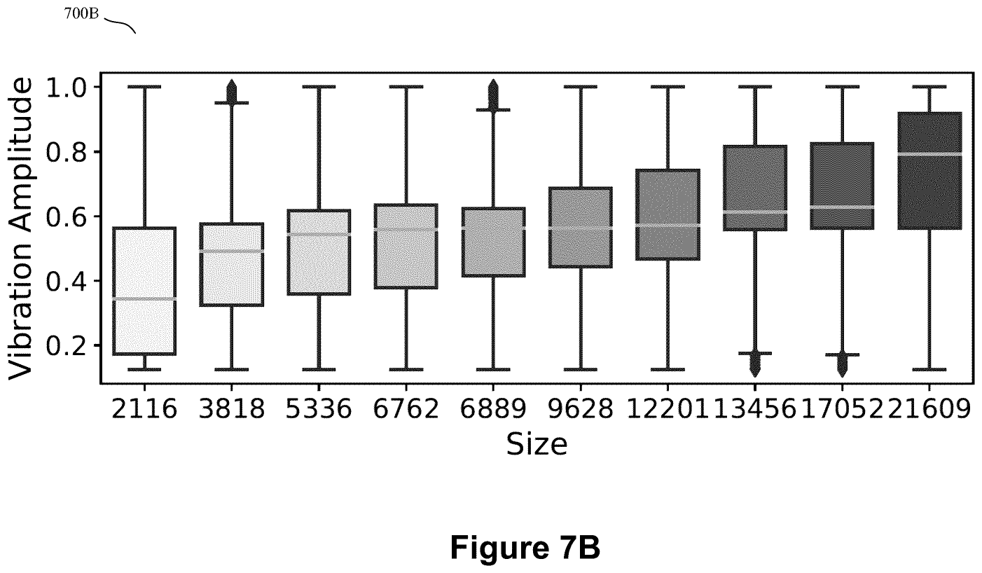

FIGS. 7A and 7B illustrate compound mappings of object size to audio pitch (r=0.101) (e.g., FIG. 7A) and object size to vibration amplitude or intensity (r=0.345) (e.g., FIG. 7B). In both FIGS. 7A and 7B, the x-axis shows the area size of the cube from small to large. In FIG. 7A, the y-axis represents the pitch in Hz. In FIG. 7B the y-axis represents the intensity.

The key findings highlight statistically significant correlations between visual color lightness and audio pitch, and between visual size and haptic intensity.

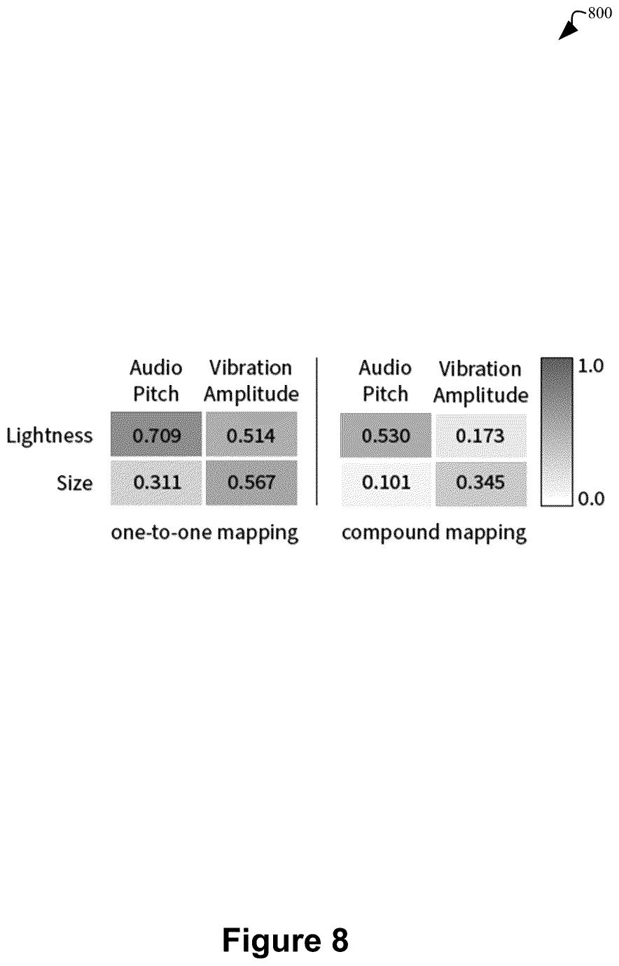

The average mapped pitch and intensity and the standard deviation for each color lightness level and size level were calculated. In addition, the Pearson correlation coefficient r to measure similarity of paired mappings were calculated. The correlation coefficients are summarized in FIG. 8 for both one-one and paired mappings.

In one-to-one mappings, color lightness and pitch are highly correlated (r>0.7) with r=0.709 for the grayscale condition and moderately correlated (r>0.5) with r=0.573 for the colored condition (p<0.001). In the compound mapping, color lightness to pitch mapping shows a moderate correlation (r=0.530, p<0.001).

In one-to-one mappings, color lightness to intensity shows moderate correlations with r=0.514 for grayscale and r=0.505 for colored conditions (p<0.001). However, in compound mapping, it has little or no correlation (r=0.173, p<0.001). FIGS. 4A and 4B show the one-to-one mappings of color lightness to pitch (FIG. 4A) and intensity (FIG. 4B), and FIGS. 5A and 5B show the mappings in the compound condition.

For size-to-intensity, one-to-one mapping shows a moderate correlation (r=0.567, p<0.001). In the compound setting, however, it shows a low correlation (r>0.3) with the coefficient (r=0.345, p<0.001). The correlation is weaker than color lightness-to-pitch mapping, but the greater the area size of the cube is, the stronger intensity participants assigned. Size-to-pitch mappings show a low correlation (r=0.311, p<0.001) for one-to-one and little or no correlation (r=0.101, p<0.001) for compound mappings. The results are visualized in FIGS. 6A and 6B and FIGS. 7A and 7B.

FIG. 8 illustrates Pearson's correlation coefficients r for color lightness/size to pitch/intensity mappings. The correlation coefficients show that lighter color is associated with higher pitch, and larger size is associated with stronger intensity, while color lightness-to-intensity or size-to-pitch have low correlations.

FIG. 9A illustrates a polynomial regression model from color lightness to pitch. FIG. 9B illustrates a polynomial regression model from size to intensity.

The findings and data from the perception study were applied to construct regression models used in the audio-haptic system: Color lightness is mapped to audio pitch with a regression model ((e.g., as illustrated in FIG. 9A) as:

$$- p = 184.05 + 0.375 * l + 0.054 * {l}^{2} \qquad Equation ( 1 )$$

where, p=pitch (in Hz) and l=object's color lightness value (l ∈[0, 1]).

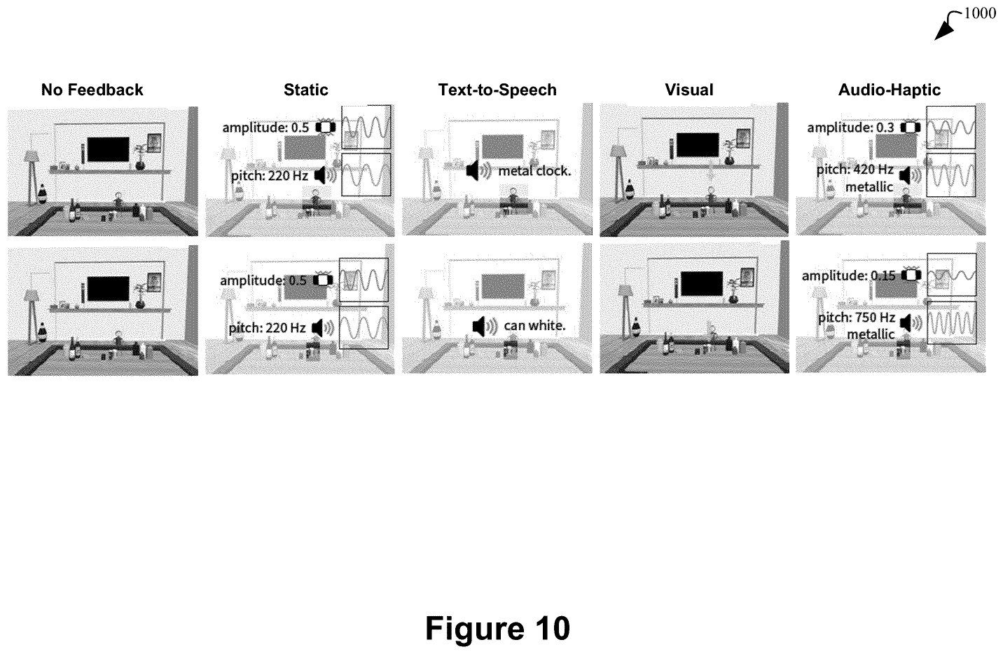

Similarly, object size is modeled to haptic intensity (FIG. 10) as:

$$a = 0.275 + 3.8 e - 05 * s - 6.01 e - 10 * {s}^{2} \qquad Equation ( 2 )$$

where, a=vibration amplitude of haptic actuators (a∈[0, 1]) and s=object's unit size.

In some embodiments, the audio-haptic system is used for everyday XR scenarios where users wear lightweight AR glasses in varying environments. These glasses may be equipped with world-facing cameras and eye tracking (e.g., smart glasses), but with no displays or limited head-locked displays. To investigate the approach, and compare against baseline techniques, the audio-haptic system was implemented with a full-display XR headset and a VR environment.

In some embodiments, for building a regression model, an interactive audio-haptic system is used for XR environment scene analysis using XR tools. As input, the audio-haptic system processes all objects in the XR scene and extracts required visual properties. The system extracts the color lightness and size of each object along with the respective object's material and horizontal direction in relation to the user's eye gaze. The system calculates color lightness by taking the average of all pixels in the base texture map or base color of the XR object. The system converts RGB color values to the CIELAB color space, and uses the L value as input to the color lightness→pitch regression model (e.g., Equation 1 from above). For size, the width and height of each object's bounding box are measured. Size values are normalized among the objects in the scene and scaled to the range of width/height values in the data collection study. The normalized and scaled values are used as input to the size→intensity regression model (e.g., Equation 2 from above).

In some embodiments, for eye gaze tracking synchronization with the audio-haptic cursor of the audio-haptic system, the in-built gaze tracker provided by the virtual-reality system is used. To compute the object the user is gazing at, the audio-haptic system uses a sphere cast with a pre-defined radius (e.g., radius of 0.1 m, 0.5 m, 1 m, heuristically defined radius, etc.) and returns the first object that collides with the sphere cast along the forward direction of the eye. As the base signal for both audio and haptic feedback, the audio-haptic system uses a pulse sine wave. When a new sphere cast collision is detected (i.e., gaze hovers over an object), the audio-haptic system plays the wave after modulating the pitch and direction of the audio wave and intensity of the vibration wave according to the regression model's output. Additionally, the audio-haptic system plays the spatialized impact response sound corresponding to the object material (see above).

In some embodiments, the audio-haptic system interfaces with a user's hand gestures and/or hand interactions. For example, a target object can be selected using the trigger button on the right controller. To switch from global to local feedback, where differences between nearby objects are amplified (as described above in FIG. 1), the trigger button on the left-hand controller is used. On holding the trigger, local feedback is enabled; releasing the trigger returns to global feedback. These controller-based interactions can be replaced with hand gestures and/or other commands in future implementations.

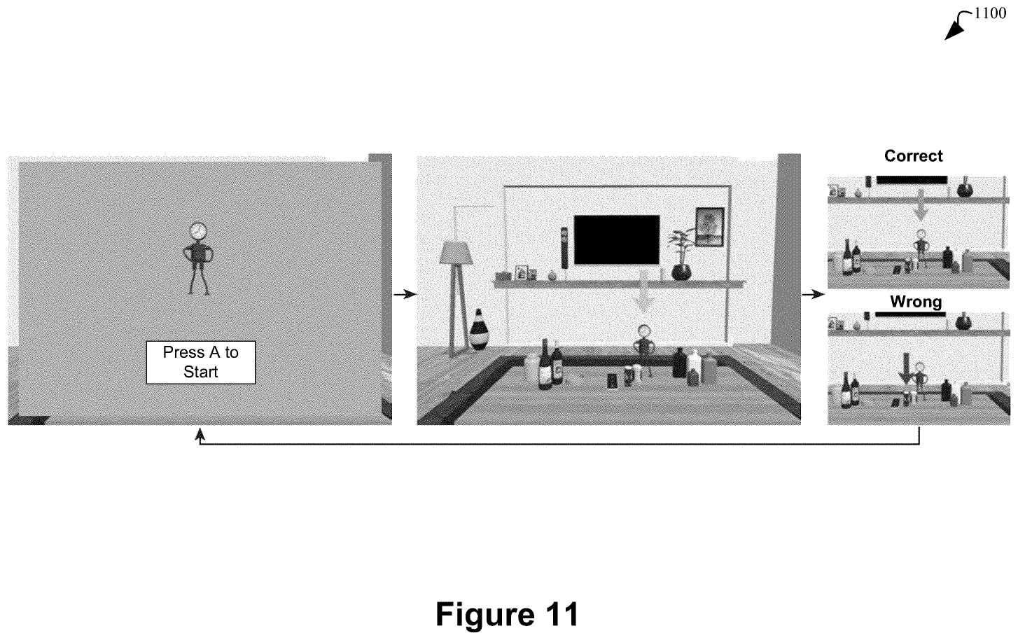

FIG. 11 illustrates a living room setting in which participants of the study performed eye gaze-based object selection tasks.

20 participants were recruited (10 female, 10 male), aged between 20 and 37 years (M=28, SD=4.6). Participants' experience with augmented reality was mean M=2 (SD=1.33) and with virtual reality M=3 (SD=1.29), on a scale from 1 (none) to 5 (expert). All participants had normal or corrected-to-normal vision, hearing, and motor abilities based on self-reports. An XR system headset was used to present a simulated XR scene to the participants. Target objects were placed near the distant wall, on or near a table, or near the sofa around each participant. Eye gaze tracking built into the XR system enabled object targeting. Participants confirmed selection by pressing a button on the XR system controllers. In some embodiments, audio feedback was delivered through the headset via in-built speakers, and the study was conducted in a quiet room. Haptic feedback was provided via a wristband with four linear resonance actuators at cardinal directions, same as the data collection study.

FIG. 10 shows an illustrative comparison between the audio-haptic system and four different object selection feedback scenarios: no feedback, static feedback, text-to-speech feedback, and visual feedback.

In some embodiments, for a system with no object selection feedback, a participant is not provided with any feedback when their eye gaze crosses an object. As such, the participant relies on the accuracy of gaze tracking techniques and has no possibilities of verifying a target object before selection.

In some embodiments, for a static feedback system, when a participant's gaze hovers over any object in the scene, the same audio and vibration cue is provided. In some embodiments, the effect is a short impulse sine wave of a constant pitch of 220.0 Hz with a duration of 0.2 sec. In some embodiments, audio is played with horizontal directionality. For the static feedback system, a participant can perceive that their gaze has moved from one object to another when completing selection tasks based on the system generating the same feedback for every object in the scene that the participant's gaze traverses.

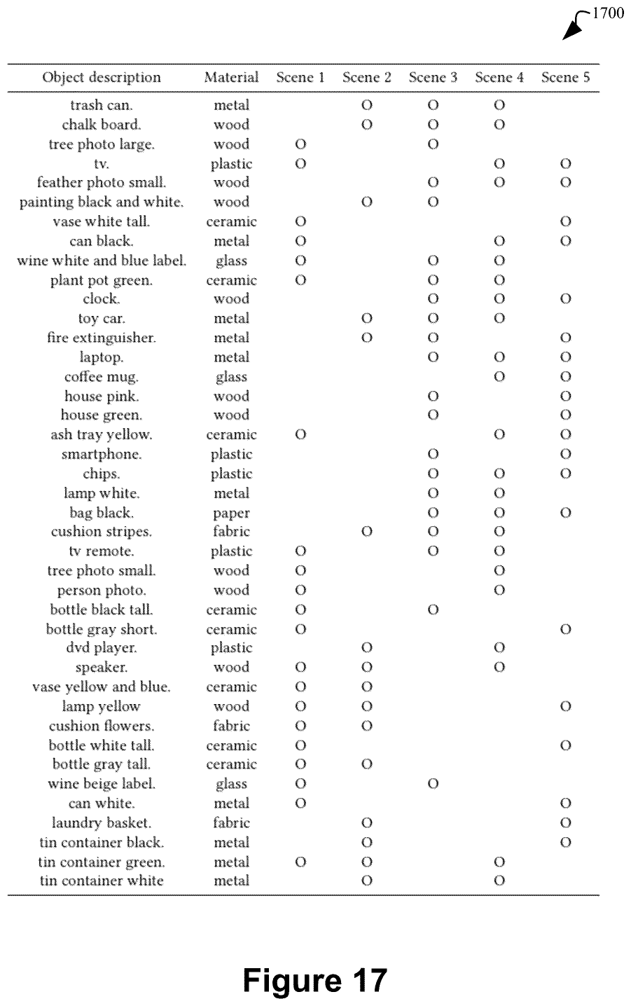

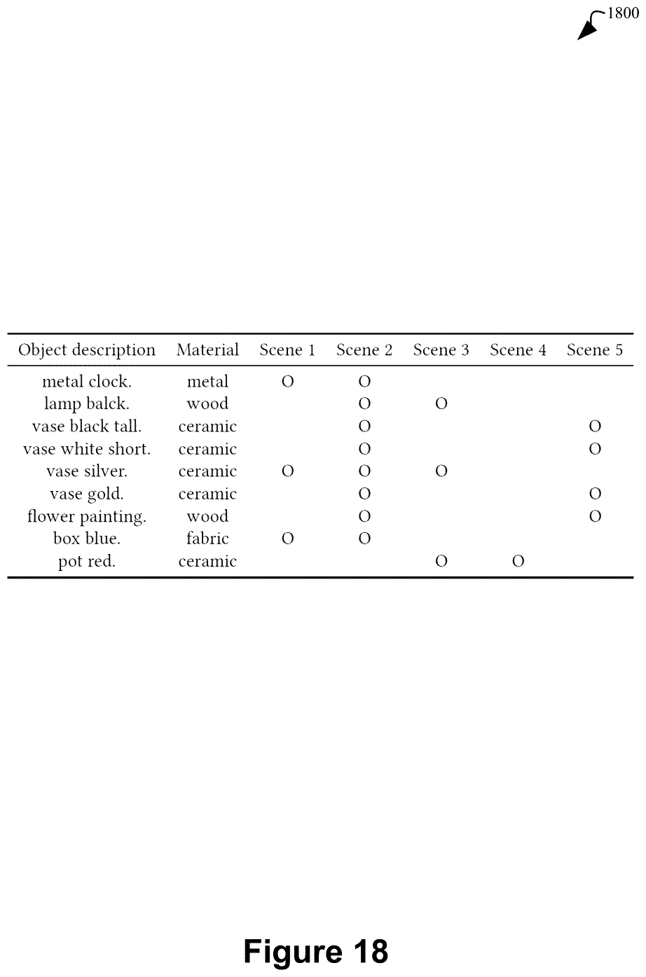

In some embodiments, for a text-to-speech feedback system, a participant can hear spoken descriptions for selected objects. In some embodiments, the corresponding object descriptions were constructed using the structure: <object name><object color><object size>. In some embodiments, object color and size information is described when there are multiple objects with common properties in the scene. For example, a list of objects and their corresponding descriptions are described in FIGS. 17 and 18. The text-to-speech feedback mechanism relies on advanced machine learning models such as object detection and speech synthesis. The best-case scenario is assumed, where every object in the scene has a unique, unambiguous description.

In some embodiments, for a visual feedback system, a blue arrow appears above the currently targeted object in the XR view. The system continuously updates the blue arrow's position as the user's gaze moves to a different object. This gaze-based feedback simulates perfectly aligned visual feedback available only in XR systems with world-locked display capabilities. While this feedback cannot be applied to no- or limited-display XR glasses, the performance of the visual feedback system is included in results of the study for comparison.

In some embodiments, for the implementation of the audio-haptic system, the system as described above (e.g., the system described in FIGS. 1-11) was used. Participants were provided with audio-haptic feedback corresponding to visual properties of objects during gaze movement.

Each feedback technique was tested in one session, resulting in five sessions. The order followed the balanced Latin square. To increase the novelty of each trial, five scenes were designed and randomly assigned to each feedback technique. Each scene had a different object set with similar average color lightness and size. Each object appeared in 2 or 3 scenes. Furthermore, each session had three different scene layouts, and in each trial, 6 objects were randomly hidden, so that participants do not memorize the object layout. For each feedback technique, participants completed 72 trials in total-24 objects in 3 different scene layouts in a randomized order.

Participants were instructed to select the given target as fast and accurately as possible. The participants were informed in advance that eye gaze tracking can be noisy and inaccurate sometimes.

In the evaluation, as shown in FIG. 11, participants were presented with the next target to select. Then, participants used eye gaze and one of the five feedback techniques to select the target. The figure shows the visual feedback condition. After selection, the system reveals whether the selection was correct (green) or not (red) with the arrow.

FIG. 11 illustrates the main task of the study in the visual feedback condition. The system first presents the next target in the center of the user's view while hiding the scene behind. The study followed a discrete procedure, where the starting point was fixed in the centered of the user's view. Then, participants used the feedback corresponding to each condition to find and select the right object by pressing the controller's ‘A’ button. After participants commit an answer, the system shows whether they selected the correct object (green arrow) or not (red arrow pointing at what they selected). If they felt impossible to select the correct object due to eye tracking errors, participants could press the ‘B’ button to give up on that trial. The system would then show a yellow arrow pointing at the correct answer.

After each condition, participants completed a post-condition survey which consists of NASA Task Load Index and perceived accuracy, speed, and confidence.

The error rate (percentage of incorrect selections), target selection time (the time from when the participant starts search after recognizing the target to when the participant commits an answer by pressing the selection button), workload, and perceived performance for each feedback technique was measured.

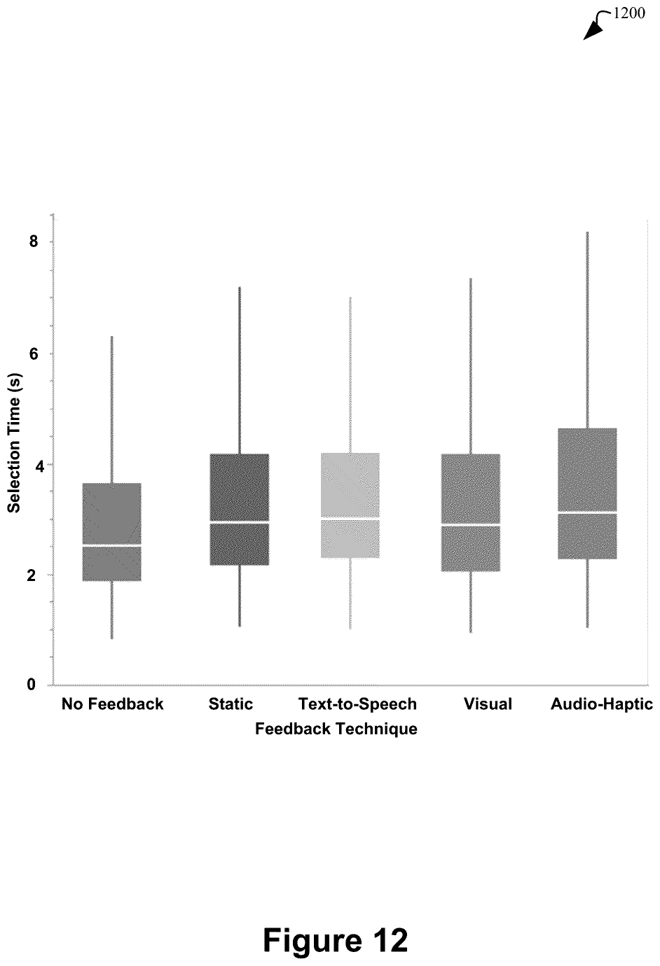

FIG. 12 illustrates the average selection time for each feedback technique. Technique had statistically significant effect on time, with ‘No Feedback’ demonstrating lowest selection time. In the comparative study, participants completed target selection tasks using 5 feedback mechanisms. Target objects varied in their sizes, location, and positioning in relation to distractor objects. For each trial, quantitative data was collected on selection time and accuracy. Additionally, qualitative data was collected on workload, performance, and user preferences. Below, in-depth analysis is provided of selection time, accuracy, and qualitative reports.

Selection time is defined as the duration from start of a trial to the moment the user confirms the target object. After running Shapiro-Wilk tests it was observed that selection time was not normally distributed, and did not fit log-normal distributions either. A non-parametric Kruskal-Wallis test with selection time (continuous) and feedback technique (nominal; 5 levels) as factors indicated that feedback technique had statistically significant effect on duration, H (2)=143.83, p<0.01. Perceived speed (1: Very Slow, 5: Very Fast) and accuracy (1: Very Inaccurate, 5: Very Accurate) showed similar results to the actual speed and accuracy. No feedback and visual feedback were perceived to be the fastest with (u=4.40, SE=0.184) and (μ=4.20, SE=0.172), followed by text-to-speech (μ=3.75, SE=0.228), static (μ=3.65, SE=0.196), and the audio-haptic system (μ=3.05, SE=0.266).

The mean selection time and standard deviation for each technique are: No feedback M=2.975 s, SD=1.564; Static M=3.391 s, SD=1.638; Text-to-Speech M=3.435 s, SD=1.572; Visual M=3.331 s, SD=1.678; and the audio-haptic system M=3.646 s, SD=1.837.

For perceived accuracy in selection, the only significant difference was between static and visual feedback (t=−3.248, p=0.017). Static feedback had the lowest perceived accuracy (μ=3.25, SE=0.239) and confidence (μ=3.35, SE=0.254) while visual feedback scored the highest perceived accuracy (μ=4.10, SE=0.161) and confidence (μ=4.35, SE=0.150).

In terms of task workload, the audio-haptic system (μ=4.30, SE=0.391) incurred higher mental demand (μ<0.001) compared to no feedback (μ=2.550, SE=0.256) and visual feedback (μ=2.600, SE=0.285). It shows that the need to learn and process a new mapping introduced mental demand as opposed to other familiar feedback techniques.

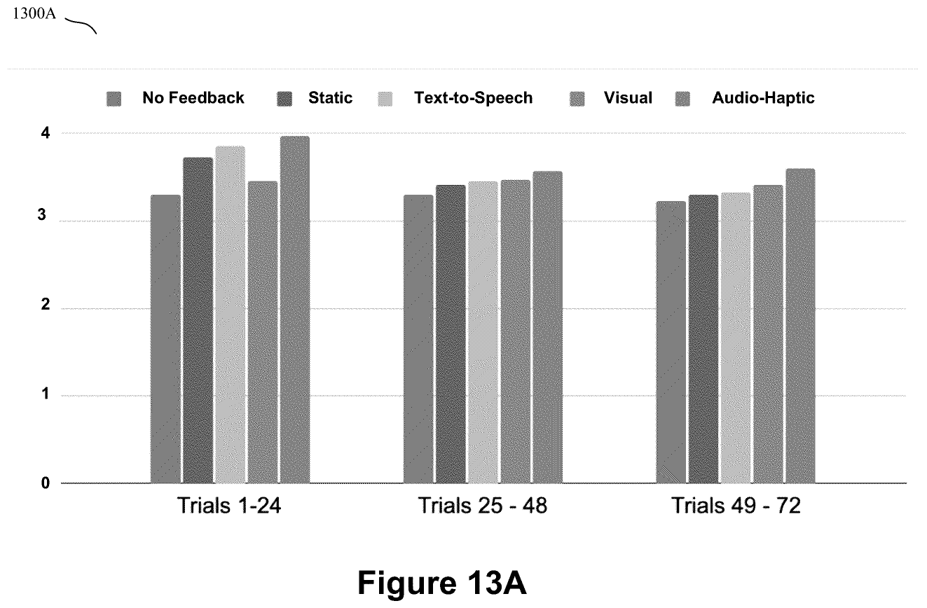

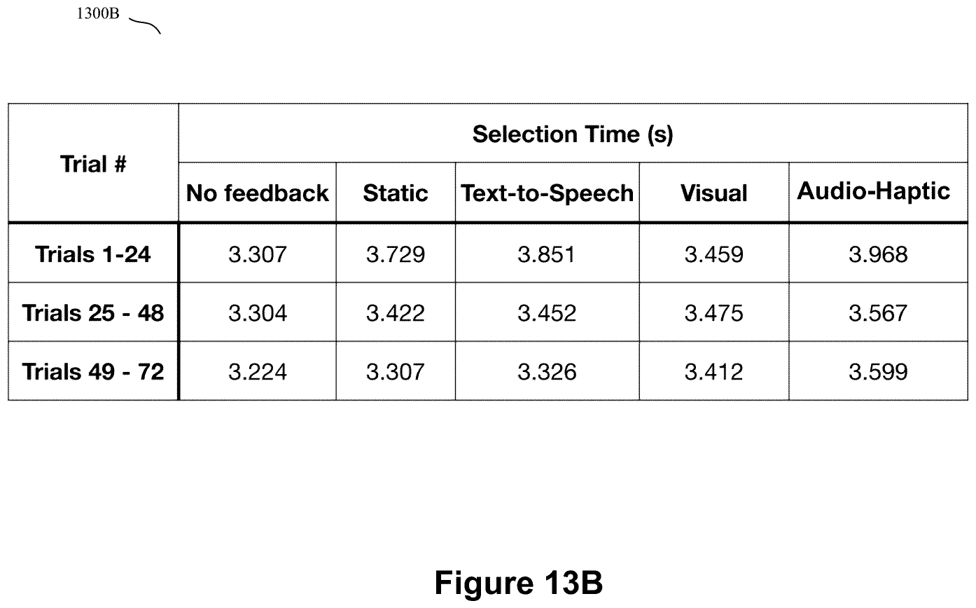

FIG. 13A illustrates and summarizes the mean selection time with the progression in trials. It is observed that selection time notably improved for the audio-haptic system and static feedback over trials.

The analysis of selection time provides some insights around performance during object selection with various feedback techniques. It was observed that all techniques can perform at competitive levels.

FIG. 13B illustrates selection time over trials in three splits. The audio-haptic system and static feedback notably improved in time over trials.

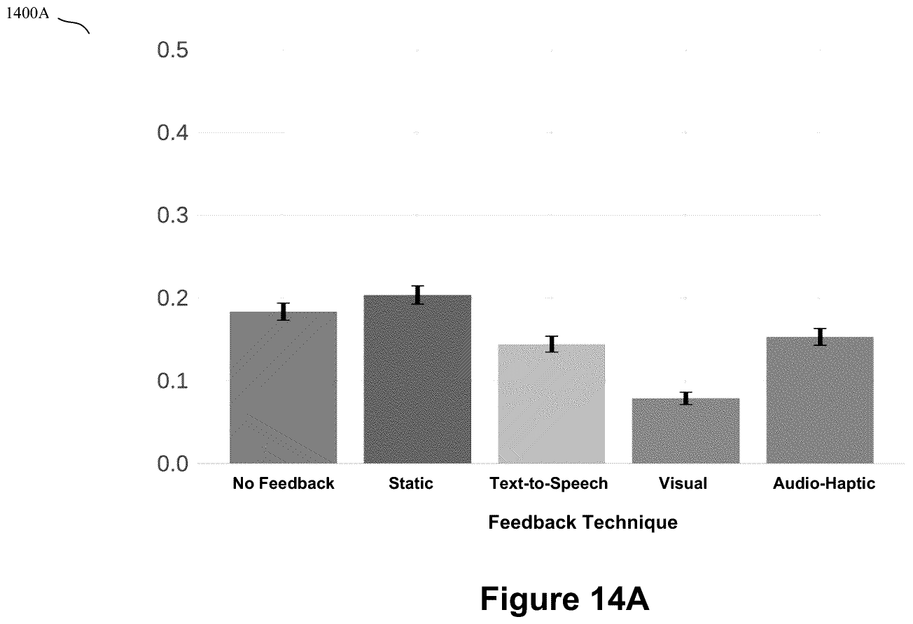

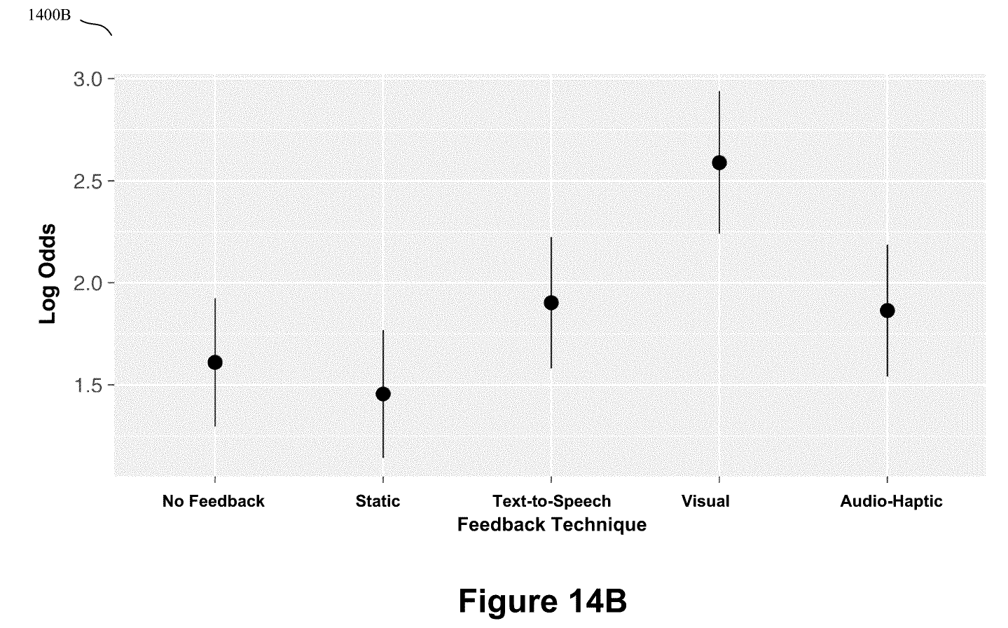

FIGS. 14A and 14B illustrate error rate correspondence with each feedback technique. FIG. 14A illustrates average error rate for each feedback technique. Error rate is the ratio of number of incorrect selections to total number of trials. Visual feedback shows the lowest average error rate of 0.078 followed by text-to-speech (0.144), the audio-haptic system (0.153), no feedback (0.183), and static feedback (0.203). While visual feedback resulted in lowest error rate, the audio-haptic system and text-to-speech outperform static and no feedback.

FIG. 14B illustrates a graphical representation of the accuracy means on the log-odds scale from mixed-effects logistic regression analysis. The log-odds scale is denoted as log (p/(1−p)), where p represents the probability of a correct outcome. Static feedback with the highest error rate showed significant contrasts with all but no feedback (z=−1.557, p=0.5252): text-to-speech (z=−4.239, p=0.0002), visual (z=−8.985, p<0.0001), and the audio-haptic system (z=−3.827, p=0.0012). Visual feedback has the highest probability of a correct outcome, followed by text-to-speech and the audio-haptic system which show no statistically significant difference.

In mixed-effects logistic regression analysis, with the binary outcome variable indicating the correctness of trial selections, the audio-haptic system shows significant contrasts to static feedback (z=3.827, p=0.0012) and visual feedback (z=−5.479, p<0.0001) but no significant difference to no feedback (z=2.358, p=0.1271) and text-to-speech (z=−0.340, p=0.9971). In the analysis, feedback technique was designated as the fixed effect, while participant identity was included as the random effect to account for inter-individual variability and maintain statistical robustness.

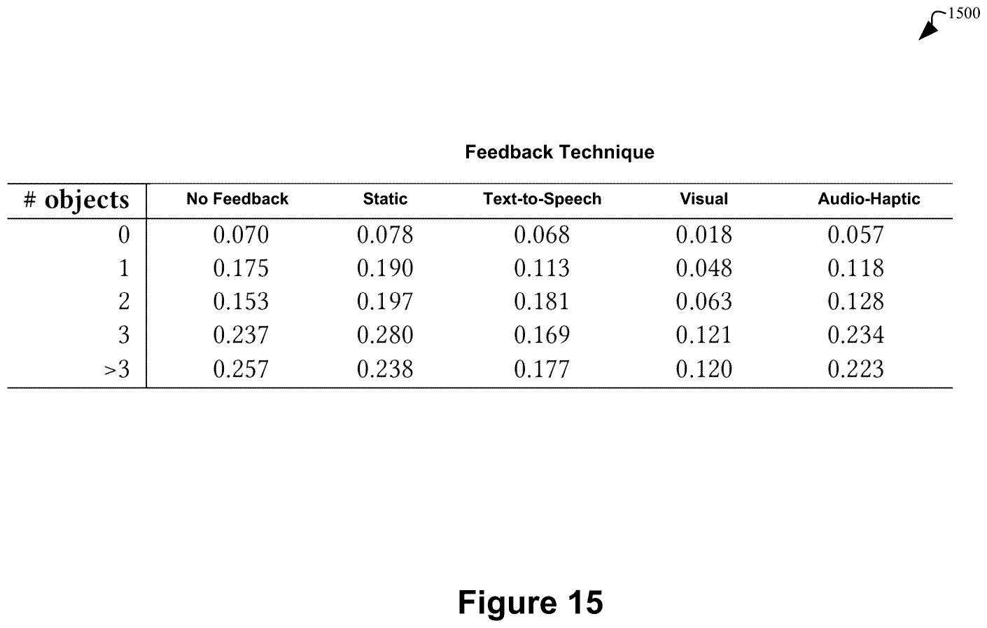

FIG. 15 summarizes the weighted average of error rate for different numbers of distractor objects near the target. In general, as clutter increases, selection accuracy reduces. The number of objects within radius r of the target object in each trial were counted, using a heuristic value of r=1 given the scene semantics.

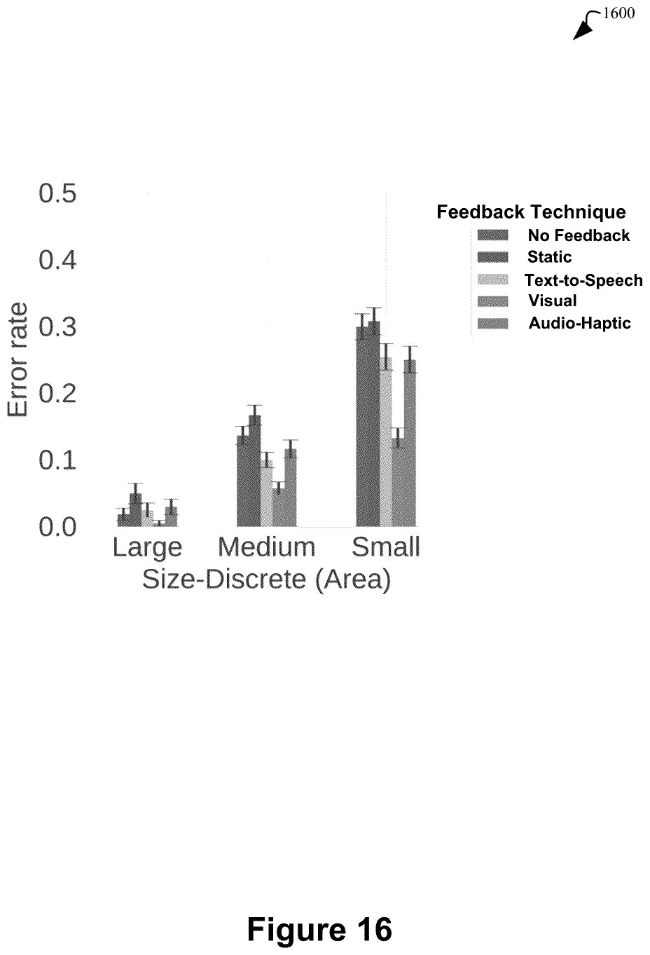

FIG. 16 illustrates the error rates by object sizes for each feedback technique. For example, the effect of different object sizes on selection accuracy and selection time was analyzed by categorizing objects into three sizes (small, medium, large) based on the size distribution of the object set. In general, smaller objects incur higher error rate and longer selection time as expected. Visual feedback achieves the lowest average error rate (0.0047 for large, 0.057 for medium, 0.132 for small) in all object sizes. For small objects, the audio-haptic system and text-to-speech follow next with 0.251 and 0.255 error rates. No feedback and static feedback achieved 0.300 and 0.308 error rates. In some embodiments, as object size decreases, error rate with no and static feedback drastically increases. These results demonstrate the value of informative and unique feedback as index of difficulty of target objects increases.

The evaluation shows that providing static feedback is worse than no feedback in terms of both accuracy and speed. Static feedback sometimes gave false confidence to participants, which eventually harmed selection accuracy. In general, a surprising and potentially-valuable result is that users can complete selection tasks with reasonably high accuracy even when no feedback is provided. This effect in the study can be attributed to the favorable setup for no feedback where participants were in a seated setup with little head movement and gaze calibration conducted before every session, which is different from daily wearable AR glasses scenarios where more drift and inaccuracy are expected. The user study condition was also favorable for text-to-speech feedback as it was assigned uniquely identifiable descriptions to all objects in the scene.

Furthermore, the increased error rate of no feedback when there were more than two objects around the target hints at the promise of adaptive feedback design for object selection. For example, a context-aware system could provide no feedback for coarse selection, when target objects are distinguishable with high confidence, and introduce more informative feedback as the user attempts to select smaller targets and cluttered regions.

FIG. 17 illustrates a first table that shows object descriptions, their materials, and what scene they are used in, in accordance with some embodiments. In some embodiments, the first object descriptions table provides information about the materials, scenes, and corresponding objects used for one or more of user studies described above.

FIG. 18 illustrates a second table that shows object descriptions, associated materials, and what scenes they are used in, in accordance with some embodiments. In some embodiments, the second object descriptions table provides information about the materials, scenes, and corresponding objects used for one or more of user studies described above.

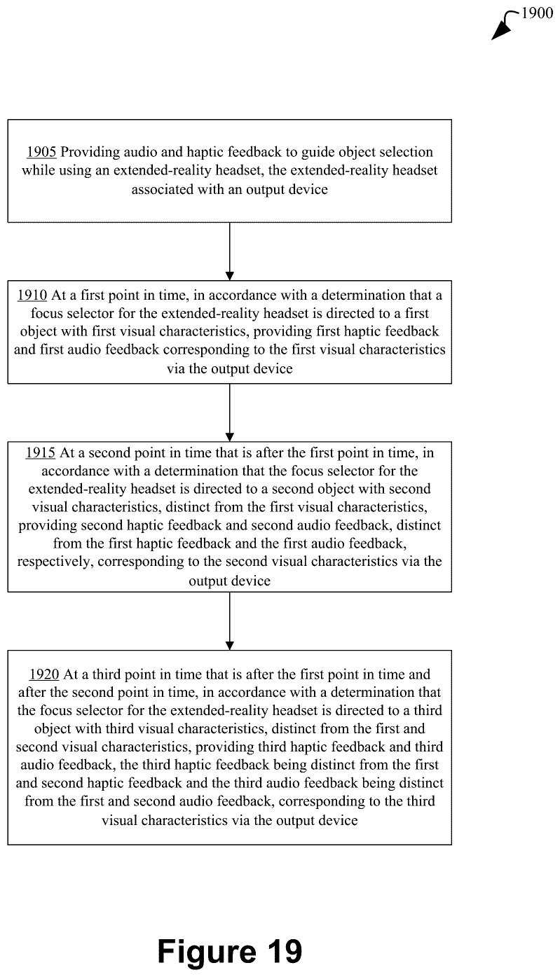

FIG. 19 illustrates an example flow diagram of method 1900 for the audio-haptic system, in accordance with some embodiments. Operations (e.g., steps) of the method 1900 can be performed by one or more processors (e.g., central processing unit and/or MCU) of a system (e.g., AR/VR/XR, smartwatch system). At least some of the operations shown in FIGS. 1, 3, 10, and 11 correspond to instructions stored in a computer memory or computer-readable storage medium (e.g., storage, RAM, and/or memory). Operations of the method 1900 can be performed by a single device alone or in conjunction with one or more processors and/or hardware components of another communicatively coupled device (e.g., AR/VR/XR device, smartwatch, etc.) and/or instructions stored in memory or computer-readable medium of the other device communicatively coupled to the system. In some embodiments, the various operations of the method described herein are interchangeable and/or optional, and respective operations of the method are performed by any of the aforementioned devices, systems, or combination of devices and/or systems. For convenience, the method operations will be described below as being performed by particular component or device, but should not be construed as limiting the performance of the operation to the particular device in all embodiments.

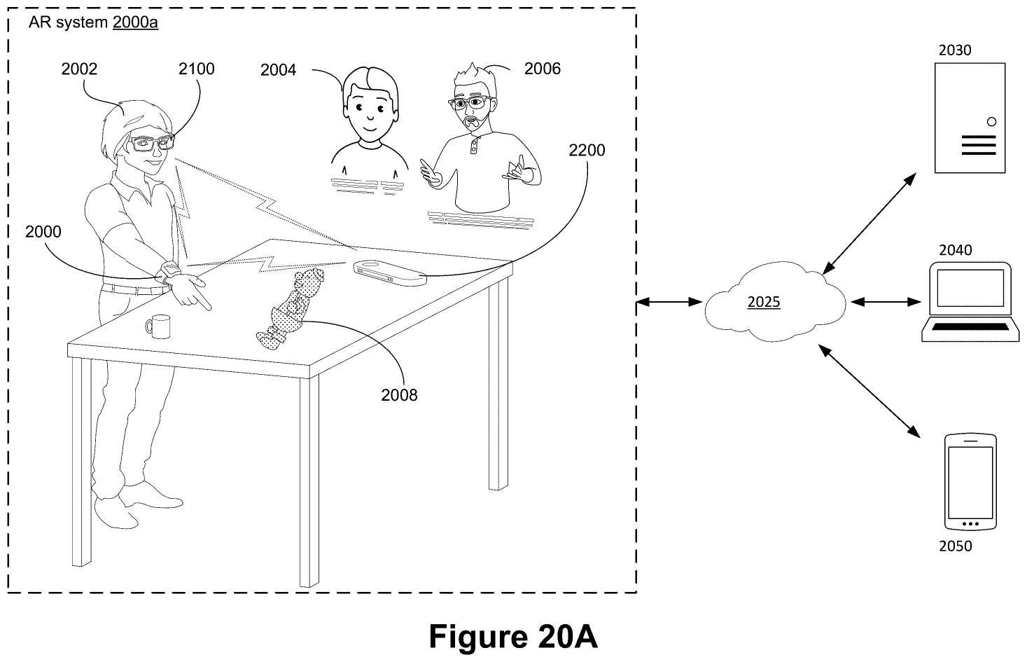

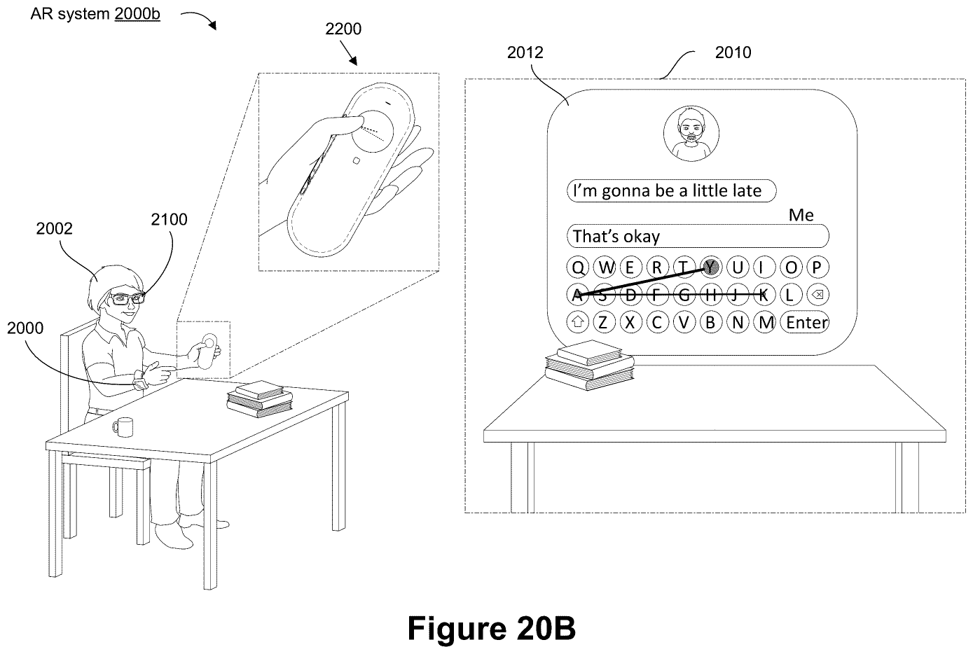

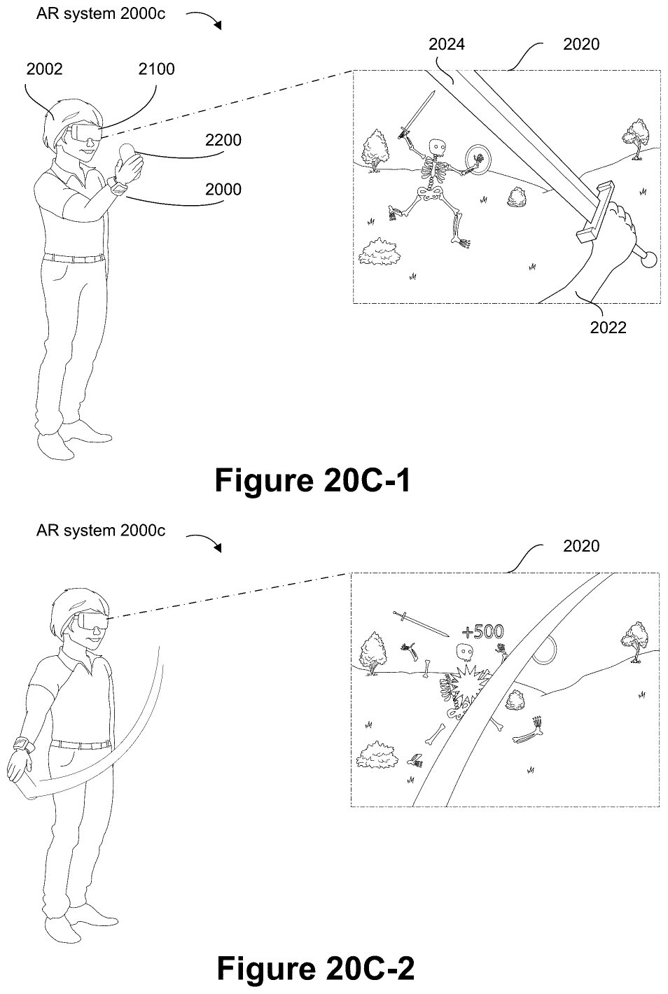

In some embodiments, the method 1900 occurs at an extended-reality headset (e.g., the AR and VR devices of FIGS. 20A-23B) in communication with an output device.
(A1) In accordance with some embodiments, the method 1900 includes a method of providing audio and haptic feedback to guide object selection while using an extended-reality headset, the extended-reality headset associated with an output device.

In some embodiments, the method 1900 includes, at a first point in time, in accordance with a determination that a focus selector for the extended-reality headset is directed to a first object with first visual characteristics, providing (1905) first haptic feedback and first audio feedback corresponding to the first visual characteristics via the output device.

In some embodiments, the method 1900 includes, at a second point in time that is after the first point in time, in accordance with a determination that the focus selector for the extended-reality headset is directed to a second object with second visual characteristics, distinct from the first visual characteristics, providing (1910) second haptic feedback and second audio feedback, distinct from the first haptic feedback and the first audio feedback, respectively, corresponding to the second visual characteristics via the output device.
(A2) In some embodiments of A1, the method 1900 includes, at a third point in time that is after the first point in time and after the second point in time, in accordance with a determination that the focus selector for the extended-reality headset is directed to a third object with third visual characteristics, distinct from the first and second visual characteristics, providing (1915) third haptic feedback and third audio feedback, the third haptic feedback being distinct from the first and second haptic feedback and the third audio feedback being distinct from the first and second audio feedback, corresponding to the third visual characteristics via the output device.
(A3) In some embodiments of any one of A1 or A2, the method 1900 includes the first and second visual characteristics include object material, object position, object color lightness, and object size; each of the first and second audio feedback is provided using respective values for includes audio timbre, audio direction, and audio pitch; and each of the first and second haptic feedback is provided using respective values for haptic intensity, wherein respective values for audio timbre are selected based on object material, respective values for audio direction are selected based on object position, respective values for audio pitch are selected based on object color lightness, and respective values for haptic intensity are selected based on object size.
(A4) In some embodiments of any one of A1 to A3, the focus selector is a gaze-based cursor.
(A5) In some embodiments of any one of A1 to A4, the output device is one of: a wrist-wearable device, a head-wearable device, or a wearable glove.
(A6) In some embodiments of any one of A1 to A5, the extended-reality device is an extended-reality headset that does not include a display.
(A7) In some embodiments of any one of A1 to A6, the first haptic feedback and the first audio feedback are provided by different devices.
(B1) In accordance with some embodiments, a system comprising an extended-reality headset that is associated with an output device is provided. The extended-reality headset is configured to perform operations including at a first point in time, in accordance with a determination that a focus selector for the extended-reality headset is directed to a first object with first visual characteristics, providing first haptic feedback and first audio feedback corresponding to the first visual characteristics via the output device. In some embodiments, the system can be configured to perform any one of (A1)-(A8).
(C1) In accordance with some embodiments, a first non-transitory, computer-readable storage medium is provided. The first a non-transitory, computer-readable storage medium includes instructions that, when executed by a wearable user device, cause the wearable device to perform or cause performance of the method of any of (A1)-(A8).
(D1) In accordance with some embodiments, a method of operating an extended reality headset, including operations that correspond to any of (A1)-(A8).

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 2000, a head-wearable device, and an HIPD 2200 or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramansors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems 20A-20C-2

FIGS. 20A, 20B, 20C-1, and 20C-2 illustrate example AR systems, in accordance with some embodiments. FIG. 20A shows a first AR system 2000a and first example user interactions using a wrist-wearable device 2000, a head-wearable device (e.g., AR device 2100), and/or a handheld intermediary processing device (HIPD) 2200. FIG. 20B shows a second AR system 2000b and second example user interactions using a wrist-wearable device 2000, AR device 2100, and/or an HIPD 2200. FIGS. 20C-1 and 20C-2 show a third AR system 2000c and third example user interactions using a wrist-wearable device 2000, a head-wearable device (e.g., virtual-reality (VR) device 2210), and/or an HIPD 2200. As the skilled artisan will appreciate upon reading the descriptions provided herein, the above-example AR systems (described in detail below) can perform various functions and/or operations described above with reference to FIGS. 1, 3, 10, 11, and 19.

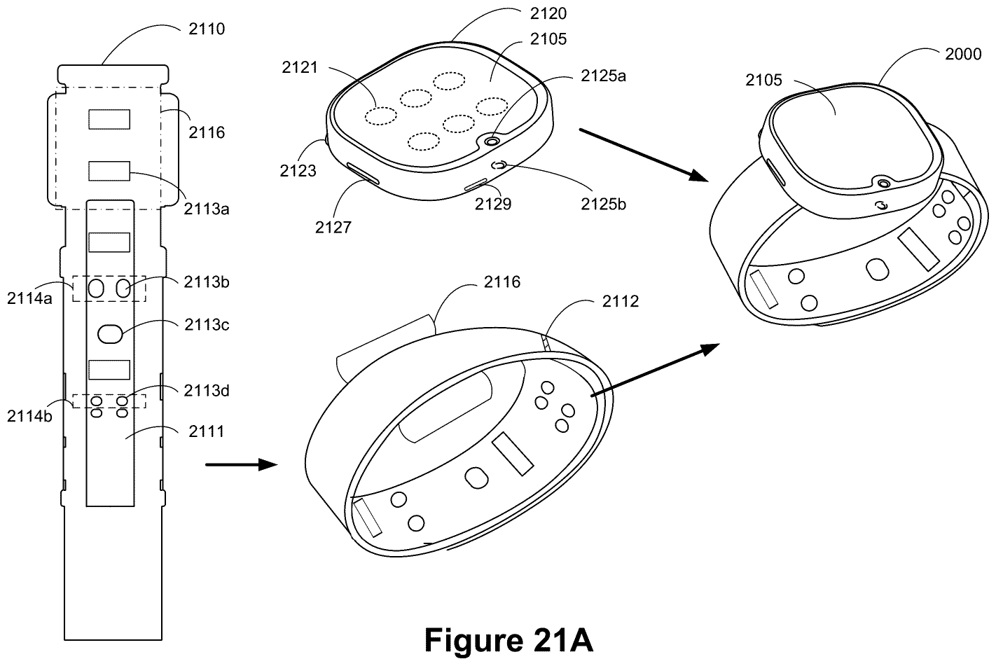

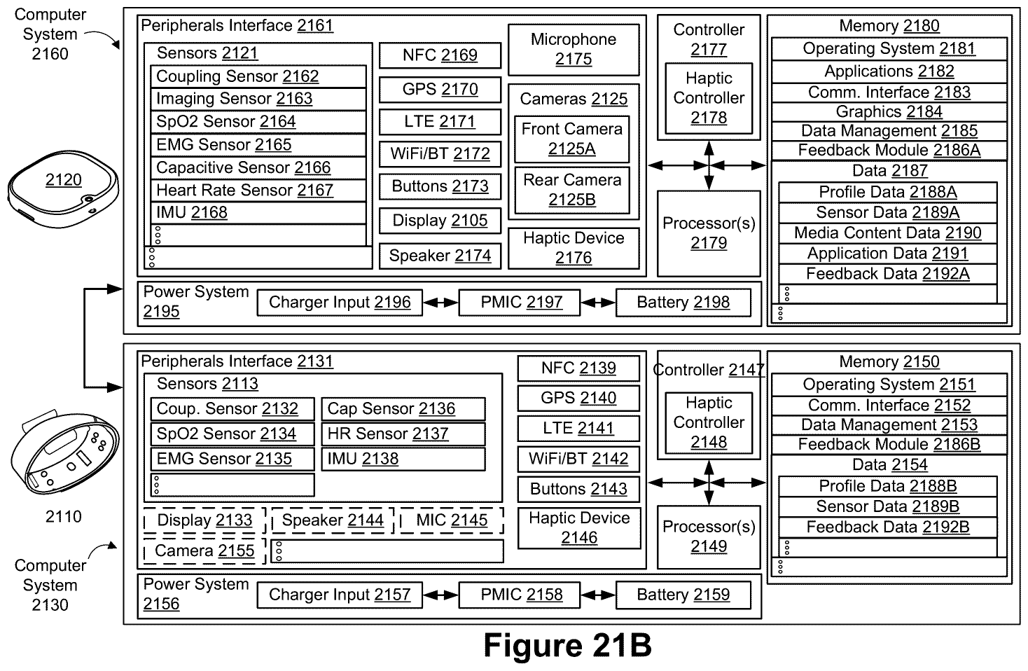

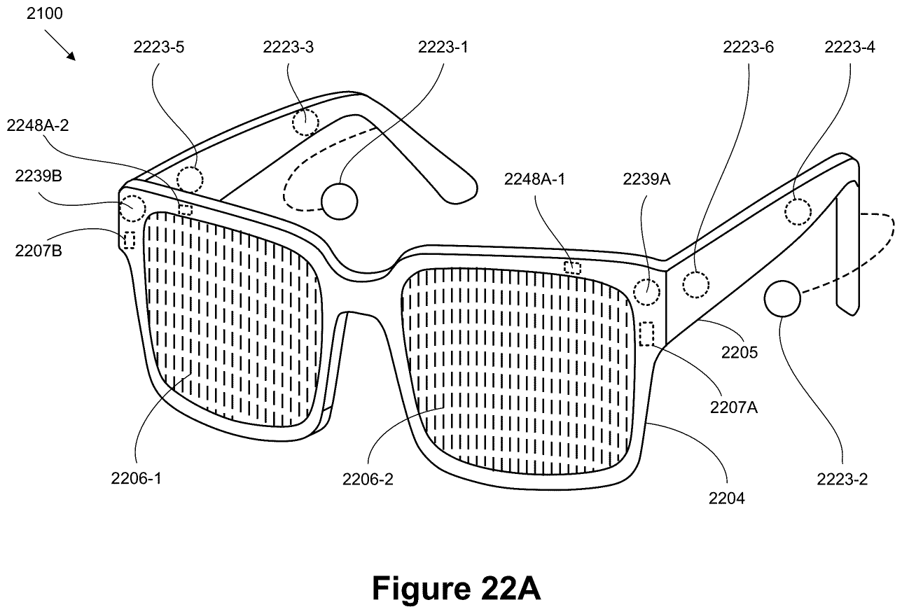

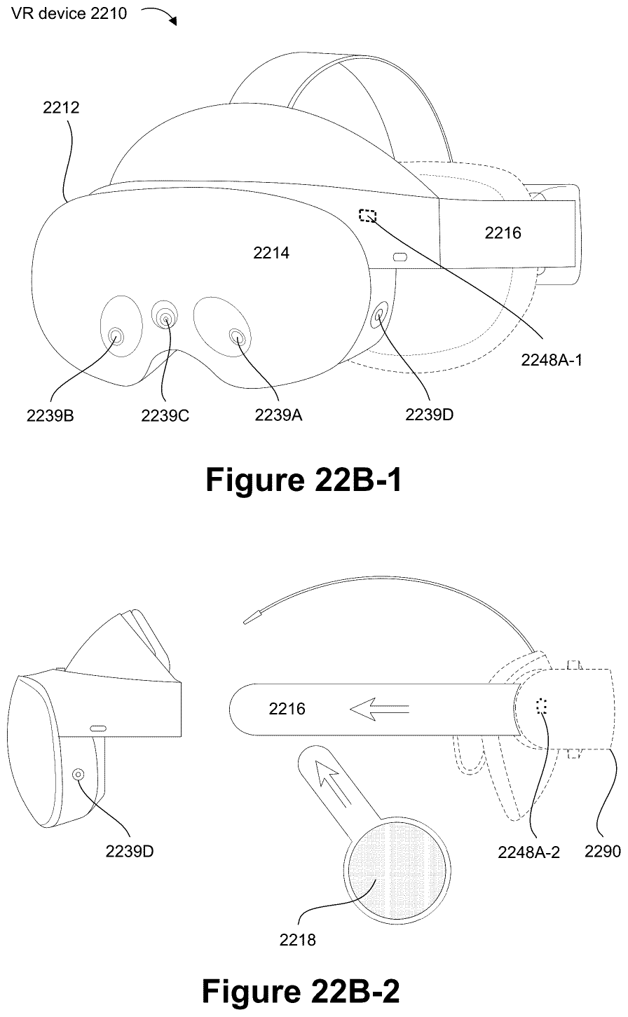

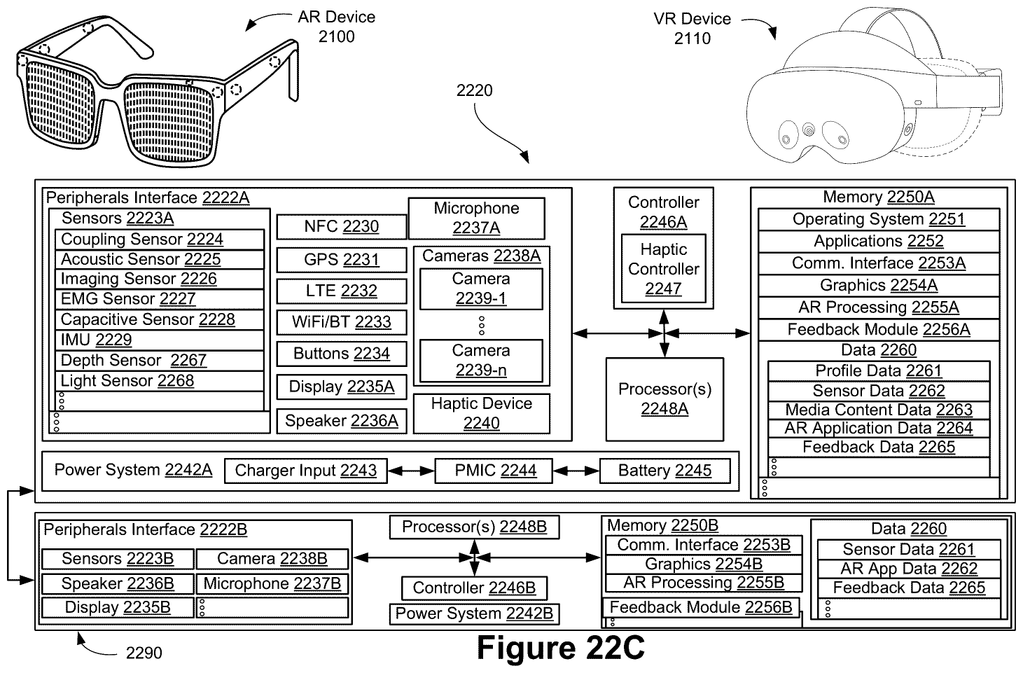

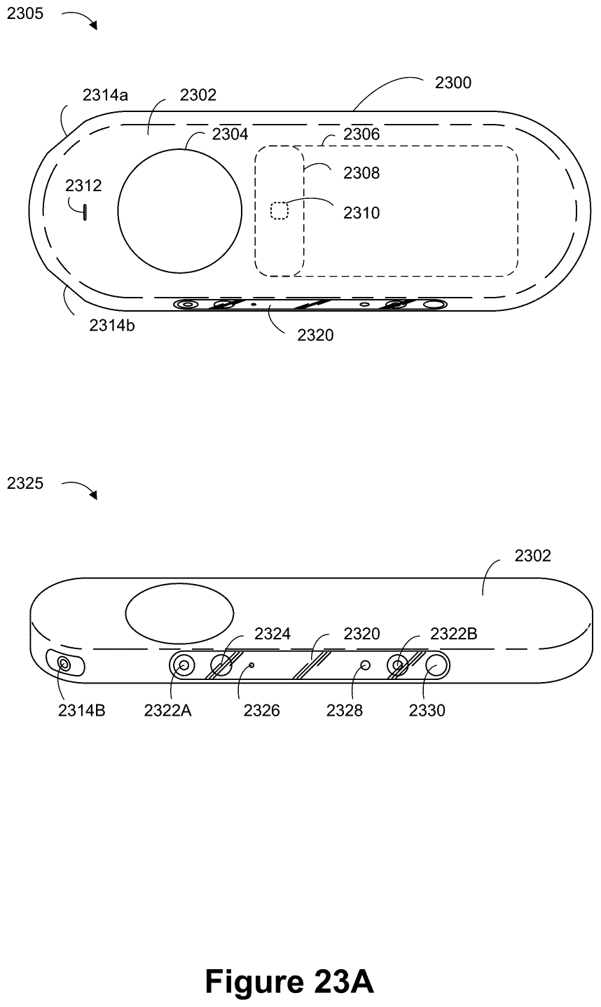

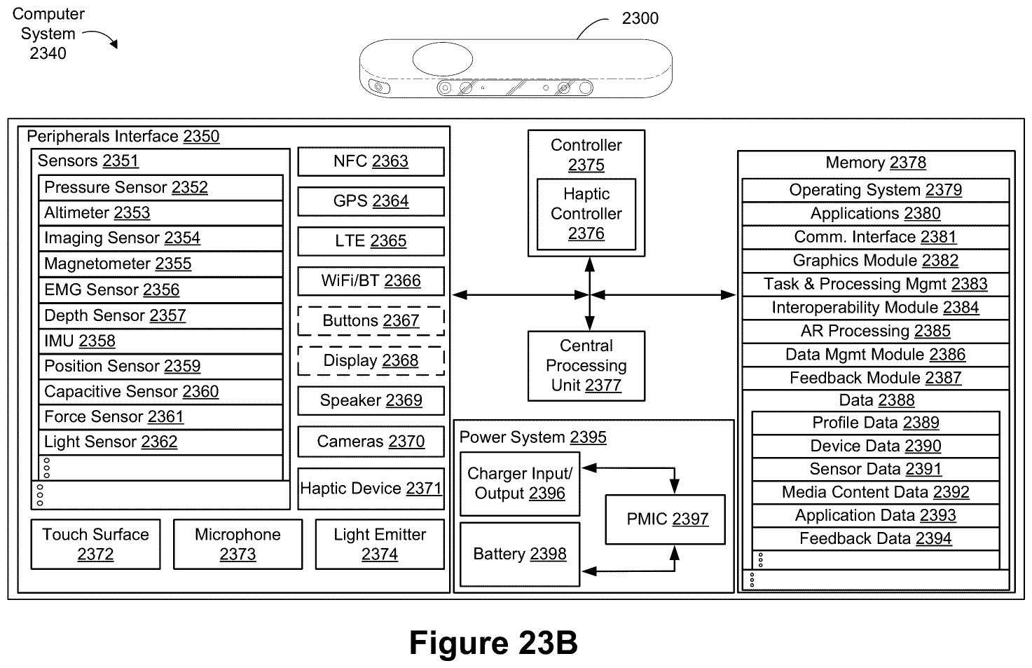

The wrist-wearable device 2000 and its constituent components are described below in reference to FIGS. 21A and 21 B, the head-wearable devices and their constituent components are described below in reference to FIGS. 22A-22D, and the HIPD 2200 and its constituent components are described below in reference to FIGS. 23A and 23B. The wrist-wearable device 2000, the head-wearable devices, and/or the HIPD 2200 can communicatively couple via a network 2025 (e.g., cellular, near field, Wi-Fi, personal area network, or wireless LAN). Additionally, the wrist-wearable device 2000, the head-wearable devices, and/or the HIPD 2200 can also communicatively couple with one or more servers 2030, computers 2040 (e.g., laptops or computers), mobile devices 2050 (e.g., smartphones or tablets), and/or other electronic devices via the network 2025 (e.g., cellular, near field, Wi-Fi, personal area network, or wireless LAN).

Turning to FIG. 20A, a user 2002 is shown wearing the wrist-wearable device 2000 and the AR device 2100, and having the HIPD 2200 on their desk. The wrist-wearable device 2000, the AR device 2100, and the HIPD 2200 facilitate user interaction with an AR environment. In particular, as shown by the first AR system 2000a, the wrist-wearable device 2000, the AR device 2100, and/or the HIPD 2200 cause presentation of one or more avatars 2004, digital representations of contacts 2006, and virtual objects 2008. As discussed below, the user 2002 can interact with the one or more avatars 2004, digital representations of the contacts 2006, and virtual objects 2008 via the wrist-wearable device 2000, the AR device 2100, and/or the HIPD 2200.

The user 2002 can use any of the wrist-wearable device 2000, the AR device 2100, and/or the HIPD 2200 to provide user inputs. For example, the user 2002 can perform one or more hand gestures that are detected by the wrist-wearable device 2000 (e.g., using one or more EMG sensors and/or IMUs, described below in reference to FIGS. 21A and 21B) and/or AR device 2100 (e.g., using one or more image sensors or cameras, described below in reference to FIGS. 22A and 22B) to provide a user input. Alternatively, or additionally, the user 2002 can provide a user input via one or more touch surfaces of the wrist-wearable device 2000, the AR device 2100, and/or the HIPD 2200, and/or voice commands captured by a microphone of the wrist-wearable device 2000, the AR device 2100, and/or the HIPD 2200. In some embodiments, the wrist-wearable device 2000, the AR device 2100, and/or the HIPD 2200 include a digital assistant to help the user in providing a user input (e.g., completing a sequence of operations, suggesting different operations or commands, providing reminders, or confirming a command). In some embodiments, the user 2002 can provide a user input via one or more facial gestures and/or facial expressions. For example, cameras of the wrist-wearable device 2000, the AR device 2100, and/or the HIPD 2200 can track the user 2002's eyes for navigating a user interface.

The wrist-wearable device 2000, the AR device 2100, and/or the HIPD 2200 can operate alone or in conjunction to allow the user 2002 to interact with the AR environment. In some embodiments, the HIPD 2200 is configured to operate as a central hub or control center for the wrist-wearable device 2000, the AR device 2100, and/or another communicatively coupled device. For example, the user 2002 can provide an input to interact with the AR environment at any of the wrist-wearable device 2000, the AR device 2100, and/or the HIPD 2200, and the HIPD 2200 can identify one or more back-end and front-end tasks to cause the performance of the requested interaction and distribute instructions to cause the performance of the one or more back-end and front-end tasks at the wrist-wearable device 2000, the AR device 2100, and/or the HIPD 2200. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). As described below in reference to FIGS. 23A and 23B, the HIPD 2200 can perform the back-end tasks and provide the wrist-wearable device 2000 and/or the AR device 2100 operational data corresponding to the performed back-end tasks such that the wrist-wearable device 2000 and/or the AR device 2100 can perform the front-end tasks. In this way, the HIPD 2200, which has more computational resources and greater thermal headroom than the wrist-wearable device 2000 and/or the AR device 2100, performs computationally intensive tasks and reduces the computer resource utilization and/or power usage of the wrist-wearable device 2000 and/or the AR device 2100.

In the example shown by the first AR system 2000a, the HIPD 2200 identifies one or more back-end tasks and front-end tasks associated with a user request to initiate an AR video call with one or more other users (represented by the avatar 2004 and the digital representation of the contact 2006) and distributes instructions to cause the performance of the one or more back-end tasks and front-end tasks. In particular, the HIPD 2200 performs back-end tasks for processing and/or rendering image data (and other data) associated with the AR video call and provides operational data associated with the performed back-end tasks to the AR device 2100 such that the AR device 2100 performs front-end tasks for presenting the AR video call (e.g., presenting the avatar 2004 and the digital representation of the contact 2006).

In some embodiments, the HIPD 2200 can operate as a focal or anchor point for causing the presentation of information. This allows the user 2002 to be generally aware of where information is presented. For example, as shown in the first AR system 2000a, the avatar 2004 and the digital representation of the contact 2006 are presented above the HIPD 2200. In particular, the HIPD 2200 and the AR device 2100 operate in conjunction to determine a location for presenting the avatar 2004 and the digital representation of the contact 2006. In some embodiments, information can be presented within a predetermined distance from the HIPD 2200 (e.g., within five meters). For example, as shown in the first AR system 2000a, virtual object 2008 is presented on the desk some distance from the HIPD 2200. Similar to the above example, the HIPD 2200 and the AR device 2100 can operate in conjunction to determine a location for presenting the virtual object 2008. Alternatively, in some embodiments, presentation of information is not bound by the HIPD 2200. More specifically, the avatar 2004, the digital representation of the contact 2006, and the virtual object 2008 do not have to be presented within a predetermined distance of the HIPD 2200.

User inputs provided at the wrist-wearable device 2000, the AR device 2100, and/or the HIPD 2200 are coordinated such that the user can use any device to initiate, continue, and/or complete an operation. For example, the user 2002 can provide a user input to the AR device 2100 to cause the AR device 2100 to present the virtual object 2008 and, while the virtual object 2008 is presented by the AR device 2100, the user 2002 can provide one or more hand gestures via the wrist-wearable device 2000 to interact and/or manipulate the virtual object 2008.

FIG. 20B shows the user 2002 wearing the wrist-wearable device 2000 and the AR device 2100, and holding the HIPD 2200. In the second AR system 2000b, the wrist-wearable device 2000, the AR device 2100, and/or the HIPD 2200 are used to receive and/or provide one or more messages to a contact of the user 2002. In particular, the wrist-wearable device 2000, the AR device 2100, and/or the HIPD 2200 detect and coordinate one or more user inputs to initiate a messaging application and prepare a response to a received message via the messaging application.

In some embodiments, the user 2002 initiates, via a user input, an application on the wrist-wearable device 2000, the AR device 2100, and/or the HIPD 2200 that causes the application to initiate on at least one device. For example, in the second AR system 2000b, the user 2002 performs a hand gesture associated with a command for initiating a messaging application (represented by messaging user interface 2012), the wrist-wearable device 2000 detects the hand gesture, and, based on a determination that the user 2002 is wearing AR device 2100, causes the AR device 2100 to present a messaging user interface 2012 of the messaging application. The AR device 2100 can present the messaging user interface 2012 to the user 2002 via its display (e.g., as shown by user 2002's field of view 2010). In some embodiments, the application is initiated and can be run on the device (e.g., the wrist-wearable device 2000, the AR device 2100, and/or the HIPD 2200) that detects the user input to initiate the application, and the device provides another device operational data to cause the presentation of the messaging application. For example, the wrist-wearable device 2000 can detect the user input to initiate a messaging application, initiate and run the messaging application, and provide operational data to the AR device 2100 and/or the HIPD 2200 to cause presentation of the messaging application. Alternatively, the application can be initiated and run at a device other than the device that detected the user input. For example, the wrist-wearable device 2000 can detect the hand gesture associated with initiating the messaging application and cause the HIPD 2200 to run the messaging application and coordinate the presentation of the messaging application.

Further, the user 2002 can provide a user input provided at the wrist-wearable device 2000, the AR device 2100, and/or the HIPD 2200 to continue and/or complete an operation initiated at another device. For example, after initiating the messaging application via the wrist-wearable device 2000 and while the AR device 2100 presents the messaging user interface 2012, the user 2002 can provide an input at the HIPD 2200 to prepare a response (e.g., shown by the swipe gesture performed on the HIPD 2200). The user 2002's gestures performed on the HIPD 2200 can be provided and/or displayed on another device. For example, the user 2002's swipe gestures performed on the HIPD 2200 are displayed on a virtual keyboard of the messaging user interface 2012 displayed by the AR device 2100.

In some embodiments, the wrist-wearable device 2000, the AR device 2100, the HIPD 2200, and/or other communicatively coupled devices can present one or more notifications to the user 2002. The notification can be an indication of a new message, an incoming call, an application update, a status update, etc. The user 2002 can select the notification via the wrist-wearable device 2000, the AR device 2100, or the HIPD 2200 and cause presentation of an application or operation associated with the notification on at least one device. For example, the user 2002 can receive a notification that a message was received at the wrist-wearable device 2000, the AR device 2100, the HIPD 2200, and/or other communicatively coupled device and provide a user input at the wrist-wearable device 2000, the AR device 2100, and/or the HIPD 2200 to review the notification, and the device detecting the user input can cause an application associated with the notification to be initiated and/or presented at the wrist-wearable device 2000, the AR device 2100, and/or the HIPD 2200.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 2100 can present to the user 2002 game application data and the HIPD 2200 can use a controller to provide inputs to the game. Similarly, the user 2002 can use the wrist-wearable device 2000 to initiate a camera of the AR device 2100, and the user can use the wrist-wearable device 2000, the AR device 2100, and/or the HIPD 2200 to manipulate the image capture (e.g., zoom in or out or apply filters) and capture image data.

Turning to FIGS. 20C-1 and 20C-2, the user 2002 is shown wearing the wrist-wearable device 2000 and a VR device 2210, and holding the HIPD 2200. In the third AR system 2000c, the wrist-wearable device 2000, the VR device 2210, and/or the HIPD 2200 are used to interact within an AR environment, such as a VR game or other AR application. While the VR device 2210 presents a representation of a VR game (e.g., first AR game environment 2020) to the user 2002, the wrist-wearable device 2000, the VR device 2210, and/or the HIPD 2200 detect and coordinate one or more user inputs to allow the user 2002 to interact with the VR game.

In some embodiments, the user 2002 can provide a user input via the wrist-wearable device 2000, the VR device 2210, and/or the HIPD 2200 that causes an action in a corresponding AR environment. For example, the user 2002 in the third AR system 2000c (shown in FIG. 20C-1) raises the HIPD 2200 to prepare for a swing in the first AR game environment 2020. The VR device 2210, responsive to the user 2002 raising the HIPD 2200, causes the AR representation of the user 2022 to perform a similar action (e.g., raise a virtual object, such as a virtual sword 2024). In some embodiments, each device uses respective sensor data and/or image data to detect the user input and provide an accurate representation of the user 2002's motion. For example, image sensors 2258 (e.g., SLAM cameras or other cameras discussed below in FIGS. 22A and 22B) of the HIPD 2200 can be used to detect a position of the 2200 relative to the user 2002's body such that the virtual object can be positioned appropriately within the first AR game environment 2020; sensor data from the wrist-wearable device 2000 can be used to detect a velocity at which the user 2002 raises the HIPD 2200 such that the AR representation of the user 2022 and the virtual sword 2024 are synchronized with the user 2002's movements; and image sensors 2126 (FIGS. 21A-21C) of the VR device 2210 can be used to represent the user 2002's body, boundary conditions, or real-world objects within the first AR game environment 2020.

In FIG. 20C-2, the user 2002 performs a downward swing while holding the HIPD 2200. The user 2002's downward swing is detected by the wrist-wearable device 2000, the VR device 2210, and/or the HIPD 2200 and a corresponding action is performed in the first AR game environment 2020. In some embodiments, the data captured by each device is used to improve the user's experience within the AR environment. For example, sensor data of the wrist-wearable device 2000 can be used to determine a speed and/or force at which the downward swing is performed and image sensors of the HIPD 2200 and/or the VR device 2210 can be used to determine a location of the swing and how it should be represented in the first AR game environment 2020, which, in turn, can be used as inputs for the AR environment (e.g., game mechanics, which can use detected speed, force, locations, and/or aspects of the user 2002's actions to classify a user's inputs (e.g., user performs a light strike, hard strike, critical strike, glancing strike, miss) or calculate an output (e.g., amount of damage)).

While the wrist-wearable device 2000, the VR device 2210, and/or the HIPD 2200 are described as detecting user inputs, in some embodiments, user inputs are detected at a single device (with the single device being responsible for distributing signals to the other devices for performing the user input). For example, the HIPD 2200 can operate an application for generating the first AR game environment 2020 and provide the VR device 2210 with corresponding data for causing the presentation of the first AR game environment 2020, as well as detect the 2002's movements (while holding the HIPD 2200) to cause the performance of corresponding actions within the first AR game environment 2020. Additionally or alternatively, in some embodiments, operational data (e.g., sensor data, image data, application data, device data, and/or other data) of one or more devices is provide to a single device (e.g., the HIPD 2200) to process the operational data and cause respective devices to perform an action associated with processed operational data.

Having discussed example AR systems, devices for interacting with such AR systems, and other computing systems more generally, devices and components will now be discussed in greater detail below. Some definitions of devices and components that can be included in some or all of the example devices discussed below are defined here for ease of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Wrist-Wearable Devices

FIGS. 21A and 21B illustrate an example wrist-wearable device 2000, in accordance with some embodiments. The wrist-wearable device 2000 is an instance of the wearable device or wearable watch band described in reference to FIGS. 1, 3, 10, and 11 herein, such that the wrist-wearable device should be understood to have the features of the wrist-wearable device 2000 and vice versa. FIG. 21A illustrates components of the wrist-wearable device 2000, which can be used individually or in combination, including combinations that include other electronic devices and/or electronic components.

FIG. 21A shows a wearable band 2110 and a watch body 2120 (or capsule) being coupled, as discussed below, to form the wrist-wearable device 2000. The wrist-wearable device 2000 can perform various functions and/or operations associated with navigating through user interfaces and selectively opening applications, as well as the functions and/or operations described above with reference to FIGS. 1,3, 10, and 11.

As will be described in more detail below, operations executed by the wrist-wearable device 2000 can include (i) presenting content to a user (e.g., displaying visual content via a display 2105); (ii) detecting (e.g., sensing) user input (e.g., sensing a touch on peripheral button 2123 and/or at a touch screen of the display 2105, a hand gesture detected by sensors (e.g., biopotential sensors)); (iii) sensing biometric data via one or more sensors 2113 (e.g., neuromuscular signals, heart rate, temperature, or sleep); messaging (e.g., text, speech, or video); image capture via one or more imaging devices or cameras 2125; wireless communications (e.g., cellular, near field, Wi-Fi, or personal area network); location determination; financial transactions; providing haptic feedback; alarms; notifications; biometric authentication; health monitoring; and/or sleep monitoring.

The above-example functions can be executed independently in the watch body 2120, independently in the wearable band 2110, and/or via an electronic communication between the watch body 2120 and the wearable band 2110. In some embodiments, functions can be executed on the wrist-wearable device 2000 while an AR environment is being presented (e.g., via one of the AR systems 2000a to 2000d). As the skilled artisan will appreciate upon reading the descriptions provided herein, the novel wearable devices described herein can be used with other types of AR environments.

The wearable band 2110 can be configured to be worn by a user such that an inner (or inside) surface of the wearable structure 2111 of the wearable band 2110 is in contact with the user's skin. When worn by a user, sensors 2113 contact the user's skin. The sensors 2113 can sense biometric data such as a user's heart rate, saturated oxygen level, temperature, sweat level, neuromuscular-signal sensors, or a combination thereof. The sensors 2113 can also sense data about a user's environment, including a user's motion, altitude, location, orientation, gait, acceleration, position, or a combination thereof. In some embodiments, the sensors 2113 are configured to track a position and/or motion of the wearable band 2110. The one or more sensors 2113 can include any of the sensors defined above and/or discussed below with respect to FIG. 21B.

The one or more sensors 2113 can be distributed on an inside and/or an outside surface of the wearable band 2110. In some embodiments, the one or more sensors 2113 are uniformly spaced along the wearable band 2110. Alternatively, in some embodiments, the one or more sensors 2113 are positioned at distinct points along the wearable band 2110. As shown in FIG. 21A, the one or more sensors 2113 can be the same or distinct. For example, in some embodiments, the one or more sensors 2113 can be shaped as a pill (e.g., sensor 2113a), an oval, a circle a square, an oblong (e.g., sensor 2113c), and/or any other shape that maintains contact with the user's skin (e.g., such that neuromuscular signal and/or other biometric data can be accurately measured at the user's skin). In some embodiments, the one or more sensors 2113 are aligned to form pairs of sensors (e.g., for sensing neuromuscular signals based on differential sensing within each respective sensor). For example, sensor 2113b is aligned with an adjacent sensor to form sensor pair 2114a, and sensor 2113d is aligned with an adjacent sensor to form sensor pair 2114b. In some embodiments, the wearable band 2110 does not have a sensor pair. Alternatively, in some embodiments, the wearable band 2110 has a predetermined number of sensor pairs (one pair of sensors, three pairs of sensors, four pairs of sensors, six pairs of sensors, or sixteen pairs of sensors).

The wearable band 2110 can include any suitable number of sensors 2113. In some embodiments, the amount and arrangements of sensors 2113 depend on the particular application for which the wearable band 2110 is used. For instance, a wearable band 2110 configured as an armband, wristband, or chest-band may include a plurality of sensors 2113 with a different number of sensors 2113 and different arrangement for each use case, such as medical use cases, compared to gaming or general day-to-day use cases.

In accordance with some embodiments, the wearable band 2110 further includes an electrical ground electrode and a shielding electrode. The electrical ground and shielding electrodes, like the sensors 2113, can be distributed on the inside surface of the wearable band 2110 such that they contact a portion of the user's skin. For example, the electrical ground and shielding electrodes can be at an inside surface of coupling mechanism 2116 or an inside surface of a wearable structure 2111. The electrical ground and shielding electrodes can be formed and/or use the same components as the sensors 2113. In some embodiments, the wearable band 2110 includes more than one electrical ground electrode and more than one shielding electrode.

The sensors 2113 can be formed as part of the wearable structure 2111 of the wearable band 2110. In some embodiments, the sensors 2113 are flush or substantially flush with the wearable structure 2111 such that they do not extend beyond the surface of the wearable structure 2111. While flush with the wearable structure 2111, the sensors 2113 are still configured to contact the user's skin (e.g., via a skin-contacting surface). Alternatively, in some embodiments, the sensors 2113 extend beyond the wearable structure 2111 a predetermined distance (e.g., 0.1 mm to 2 mm) to make contact and depress into the user's skin. In some embodiments, the sensors 2113 are coupled to an actuator (not shown) configured to adjust an extension height (e.g., a distance from the surface of the wearable structure 2111) of the sensors 2113 such that the sensors 2113 make contact and depress into the user's skin. In some embodiments, the actuators adjust the extension height between 0.01 mm to 1.2 mm. This allows the user to customize the positioning of the sensors 2113 to improve the overall comfort of the wearable band 2110 when worn while still allowing the sensors 2113 to contact the user's skin. In some embodiments, the sensors 2113 are indistinguishable from the wearable structure 2111 when worn by the user.

The wearable structure 2111 can be formed of an elastic material, elastomers, etc., configured to be stretched and fitted to be worn by the user. In some embodiments, the wearable structure 2111 is a textile or woven fabric. As described above, the sensors 2113 can be formed as part of a wearable structure 2111. For example, the sensors 2113 can be molded into the wearable structure 2111 or be integrated into a woven fabric (e.g., the sensors 2113 can be sewn into the fabric and mimic the pliability of fabric (e.g., the sensors 2113 can be constructed from a series of woven strands of fabric)).

The wearable structure 2111 can include flexible electronic connectors that interconnect the sensors 2113, the electronic circuitry, and/or other electronic components (described below in reference to FIG. 21B) that are enclosed in the wearable band 2110. In some embodiments, the flexible electronic connectors are configured to interconnect the sensors 2113, the electronic circuitry, and/or other electronic components of the wearable band 2110 with respective sensors and/or other electronic components of another electronic device (e.g., watch body 2120). The flexible electronic connectors are configured to move with the wearable structure 2111 such that the user adjustment to the wearable structure 2111 (e.g., resizing, pulling, or folding) does not stress or strain the electrical coupling of components of the wearable band 2110.

As described above, the wearable band 2110 is configured to be worn by a user. In particular, the wearable band 2110 can be shaped or otherwise manipulated to be worn by a user. For example, the wearable band 2110 can be shaped to have a substantially circular shape such that it can be configured to be worn on the user's lower arm or wrist. Alternatively, the wearable band 2110 can be shaped to be worn on another body part of the user, such as the user's upper arm (e.g., around a bicep), forearm, chest, legs, etc. The wearable band 2110 can include a retaining mechanism 2112 (e.g., a buckle or a hook and loop fastener) for securing the wearable band 2110 to the user's wrist or other body part. While the wearable band 2110 is worn by the user, the sensors 2113 sense data (referred to as sensor data) from the user's skin. In particular, the sensors 2113 of the wearable band 2110 obtain (e.g., sense and record) neuromuscular signals.

The sensed data (e.g., sensed neuromuscular signals) can be used to detect and/or determine the user's intention to perform certain motor actions. In particular, the sensors 2113 sense and record neuromuscular signals from the user as the user performs muscular activations (e.g., movements or gestures). The detected and/or determined motor action (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 2005 of the wrist-wearable device 2000 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 2113 can be used to provide a user with an enhanced interaction with a physical object (e.g., devices communicatively coupled with the wearable band 2110) and/or a virtual object in an AR application generated by an AR system (e.g., user interface objects presented on the display 2105 or another computing device (e.g., a smartphone)).

In some embodiments, the wearable band 2110 includes one or more haptic devices 2146 (FIG. 21B; e.g., a vibratory haptic actuator) that are configured to provide haptic feedback (e.g., a cutaneous and/or kinesthetic sensation) to the user's skin. The sensors 2113 and/or the haptic devices 2146 can be configured to operate in conjunction with multiple applications including, without limitation, health monitoring, social media, games, and AR (e.g., the applications associated with AR).

The wearable band 2110 can also include a coupling mechanism 2116 (e.g., a cradle or a shape of the coupling mechanism can correspond to the shape of the watch body 2120 of the wrist-wearable device 2000) for detachably coupling a capsule (e.g., a computing unit) or watch body 2120 (via a coupling surface of the watch body 2120) to the wearable band 2110. In particular, the coupling mechanism 2116 can be configured to receive a coupling surface proximate to the bottom side of the watch body 2120 (e.g., a side opposite to a front side of the watch body 2120 where the display 2105 is located), such that a user can push the watch body 2120 downward into the coupling mechanism 2116 to attach the watch body 2120 to the coupling mechanism 2116. In some embodiments, the coupling mechanism 2116 can be configured to receive a top side of the watch body 2120 (e.g., a side proximate to the front side of the watch body 2120 where the display 2105 is located) that is pushed upward into the cradle, as opposed to being pushed downward into the coupling mechanism 2116. In some embodiments, the coupling mechanism 2116 is an integrated component of the wearable band 2110 such that the wearable band 2110 and the coupling mechanism 2116 are a single unitary structure. In some embodiments, the coupling mechanism 2116 is a type of frame or shell that allows the watch body 2120 coupling surface to be retained within or on the wearable band 2110 coupling mechanism 2116 (e.g., a cradle, a tracker band, a support base, or a clasp).

The coupling mechanism 2116 can allow for the watch body 2120 to be detachably coupled to the wearable band 2110 through a friction fit, a magnetic coupling, a rotation-based connector, a shear-pin coupler, a retention spring, one or more magnets, a clip, a pin shaft, a hook-and-loop fastener, or a combination thereof. A user can perform any type of motion to couple the watch body 2120 to the wearable band 2110 and to decouple the watch body 2120 from the wearable band 2110. For example, a user can twist, slide, turn, push, pull, or rotate the watch body 2120 relative to the wearable band 2110, or a combination thereof, to attach the watch body 2120 to the wearable band 2110 and to detach the watch body 2120 from the wearable band 2110. Alternatively, as discussed below, in some embodiments, the watch body 2120 can be decoupled from the wearable band 2110 by actuation of the release mechanism 2129.

The wearable band 2110 can be coupled with a watch body 2120 to increase the functionality of the wearable band 2110 (e.g., converting the wearable band 2110 into a wrist-wearable device 2000, adding an additional computing unit and/or battery to increase computational resources and/or a battery life of the wearable band 2110, or adding additional sensors to improve sensed data). As described above, the wearable band 2110 (and the coupling mechanism 2116) is configured to operate independently (e.g., execute functions independently) from watch body 2120. For example, the coupling mechanism 2116 can include one or more sensors 2113 that contact a user's skin when the wearable band 2110 is worn by the user and provide sensor data for determining control commands.

A user can detach the watch body 2120 (or capsule) from the wearable band 2110 in order to reduce the encumbrance of the wrist-wearable device 2000 to the user. For embodiments in which the watch body 2120 is removable, the watch body 2120 can be referred to as a removable structure, such that in these embodiments the wrist-wearable device 2000 includes a wearable portion (e.g., the wearable band 2110) and a removable structure (the watch body 2120).

Turning to the watch body 2120, the watch body 2120 can have a substantially rectangular or circular shape. The watch body 2120 is configured to be worn by the user on their wrist or on another body part. More specifically, the watch body 2120 is sized to be easily carried by the user, attached on a portion of the user's clothing, and/or coupled to the wearable band 2110 (forming the wrist-wearable device 2000). As described above, the watch body 2120 can have a shape corresponding to the coupling mechanism 2116 of the wearable band 2110. In some embodiments, the watch body 2120 includes a single release mechanism 2129 or multiple release mechanisms (e.g., two release mechanisms 2129 positioned on opposing sides of the watch body 2120, such as spring-loaded buttons) for decoupling the watch body 2120 and the wearable band 2110. The release mechanism 2129 can include, without limitation, a button, a knob, a plunger, a handle, a lever, a fastener, a clasp, a dial, a latch, or a combination thereof.

A user can actuate the release mechanism 2129 by pushing, turning, lifting, depressing, shifting, or performing other actions on the release mechanism 2129. Actuation of the release mechanism 2129 can release (e.g., decouple) the watch body 2120 from the coupling mechanism 2116 of the wearable band 2110, allowing the user to use the watch body 2120 independently from wearable band 2110 and vice versa. For example, decoupling the watch body 2120 from the wearable band 2110 can allow the user to capture images using rear-facing camera 2125b. Although the coupling mechanism 2116 is shown positioned at a corner of watch body 2120, the release mechanism 2129 can be positioned anywhere on watch body 2120 that is convenient for the user to actuate. In addition, in some embodiments, the wearable band 2110 can also include a respective release mechanism for decoupling the watch body 2120 from the coupling mechanism 2116. In some embodiments, the release mechanism 2129 is optional and the watch body 2120 can be decoupled from the coupling mechanism 2116, as described above (e.g., via twisting or rotating).

The watch body 2120 can include one or more peripheral buttons 2123 and 2127 for performing various operations at the watch body 2120. For example, the peripheral buttons 2123 and 2127 can be used to turn on or wake (e.g., transition from a sleep state to an active state) the display 2105, unlock the watch body 2120, increase or decrease volume, increase, or decrease brightness, interact with one or more applications, interact with one or more user interfaces. Additionally, or alternatively, in some embodiments, the display 2105 operates as a touch screen and allows the user to provide one or more inputs for interacting with the watch body 2120.

In some embodiments, the watch body 2120 includes one or more sensors 2121. The sensors 2121 of the watch body 2120 can be the same or distinct from the sensors 2113 of the wearable band 2110. The sensors 2121 of the watch body 2120 can be distributed on an inside and/or an outside surface of the watch body 2120. In some embodiments, the sensors 2121 are configured to contact a user's skin when the watch body 2120 is worn by the user. For example, the sensors 2121 can be placed on the bottom side of the watch body 2120 and the coupling mechanism 2116 can be a cradle with an opening that allows the bottom side of the watch body 2120 to directly contact the user's skin. Alternatively, in some embodiments, the watch body 2120 does not include sensors that are configured to contact the user's skin (e.g., including sensors internal and/or external to the watch body 2120 that are configured to sense data of the watch body 2120 and the watch body 2120's surrounding environment). In some embodiments, the sensors 2113 are configured to track a position and/or motion of the watch body 2120.

The watch body 2120 and the wearable band 2110 can share data using a wired communication method (e.g., a Universal Asynchronous Receiver/Transmitter (UART) or a USB transceiver) and/or a wireless communication method (e.g., near-field communication or Bluetooth). For example, the watch body 2120 and the wearable band 2110 can share data sensed by the sensors 2113 and 2121, as well as application- and device-specific information (e.g., active and/or available applications), output devices (e.g., display or speakers), and/or input devices (e.g., touch screens, microphones, or imaging sensors).

In some embodiments, the watch body 2120 can include, without limitation, a front-facing camera 2125a and/or a rear-facing camera 2125b, sensors 2121 (e.g., a biometric sensor, an IMU sensor, a heart rate sensor, a saturated oxygen sensor, a neuromuscular-signal sensor, an altimeter sensor, a temperature sensor, a bioimpedance sensor, a pedometer sensor, an optical sensor (e.g., FIG. 21B; imaging sensor 2163), a touch sensor, a sweat sensor). In some embodiments, the watch body 2120 can include one or more haptic devices 2176 (FIG. 21B; a vibratory haptic actuator) that is configured to provide haptic feedback (e.g., a cutaneous and/or kinesthetic sensation) to the user. The sensors 2121 and/or the haptic device 2176 can also be configured to operate in conjunction with multiple applications, including, without limitation, health-monitoring applications, social media applications, game applications, and AR applications (e.g., the applications associated with AR).

As described above, the watch body 2120 and the wearable band 2110, when coupled, can form the wrist-wearable device 2000. When coupled, the watch body 2120 and wearable band 2110 operate as a single device to execute functions (e.g., operations, detections, or communications) described herein. In some embodiments, each device is provided with particular instructions for performing the one or more operations of the wrist-wearable device 2000. For example, in accordance with a determination that the watch body 2120 does not include neuromuscular-signal sensors, the wearable band 2110 can include alternative instructions for performing associated instructions (e.g., providing sensed neuromuscular-signal data to the watch body 2120 via a different electronic device). Operations of the wrist-wearable device 2000 can be performed by the watch body 2120 alone or in conjunction with the wearable band 2110 (e.g., via respective processors and/or hardware components) and vice versa. In some embodiments, operations of the wrist-wearable device 2000, the watch body 2120, and/or the wearable band 2110 can be performed in conjunction with one or more processors and/or hardware components of another communicatively coupled device (e.g., FIGS. 23A and 23B; the HIPD 2300).

As described below with reference to the block diagram of FIG. 21B, the wearable band 2110 and/or the watch body 2120 can each include independent resources required to independently execute functions. For example, the wearable band 2110 and/or the watch body 2120 can each include a power source (e.g., a battery), a memory, data storage, a processor (e.g., a CPU), communications, a light source, and/or input/output devices.

FIG. 21B shows block diagrams of a computing system 2130 corresponding to the wearable band 2110 and a computing system 2160 corresponding to the watch body 2120, according to some embodiments. A computing system of the wrist-wearable device 2000 includes a combination of components of the wearable band computing system 2130 and the watch body computing system 2160, in accordance with some embodiments.

The watch body 2120 and/or the wearable band 2110 can include one or more components shown in watch body computing system 2160. In some embodiments, a single integrated circuit includes all or a substantial portion of the components of the watch body computing system 2160 that are included in a single integrated circuit. Alternatively, in some embodiments, components of the watch body computing system 2160 are included in a plurality of integrated circuits that are communicatively coupled. In some embodiments, the watch body computing system 2160 is configured to couple (e.g., via a wired or wireless connection) with the wearable band computing system 2130, which allows the computing systems to share components, distribute tasks, and/or perform other operations described herein (individually or as a single device).

The watch body computing system 2160 can include one or more processors 2179, a controller 2177, a peripherals interface 2161, a power system 2195, and memory (e.g., a memory 2180), each of which are defined above and described in more detail below.

The power system 2195 can include a charger input 2196, a power-management integrated circuit (PMIC) 2197, and a battery 2198, each of which are defined above. In some embodiments, a watch body 2120 and a wearable band 2110 can have respective charger inputs (e.g., charger inputs 2196 and 2157), respective batteries (e.g., batteries 2198 and 2159), and can share power with each other (e.g., the watch body 2120 can power and/or charge the wearable band 2110 and vice versa). Although watch body 2120 and/or the wearable band 2110 can include respective charger inputs, a single charger input can charge both devices when coupled. The watch body 2120 and the wearable band 2110 can receive a charge using a variety of techniques. In some embodiments, the watch body 2120 and the wearable band 2110 can use a wired charging assembly (e.g., power cords) to receive the charge. Alternatively, or in addition, the watch body 2120 and/or the wearable band 2110 can be configured for wireless charging. For example, a portable charging device can be designed to mate with a portion of watch body 2120 and/or wearable band 2110 and wirelessly deliver usable power to a battery of watch body 2120 and/or wearable band 2110. The watch body 2120 and the wearable band 2110 can have independent power systems (e.g., power system 2195 and 2156) to enable each to operate independently. The watch body 2120 and wearable band 2110 can also share power (e.g., one can charge the other) via respective PMICs (e.g., PMICs 2197 and 2158) that can share power over power and ground conductors and/or over wireless charging antennas.

In some embodiments, the peripherals interface 2161 can include one or more sensors 2121, many of which listed below are defined above. The sensors 2121 can include one or more coupling sensors 2162 for detecting when the watch body 2120 is coupled with another electronic device (e.g., a wearable band 2110). The sensors 2121 can include imaging sensors 2163 (one or more of the cameras 2125 and/or separate imaging sensors 2163 (e.g., thermal-imaging sensors)). In some embodiments, the sensors 2121 include one or more SpO2 sensors 2164. In some embodiments, the sensors 2121 include one or more biopotential-signal sensors (e.g., EMG sensors 2165, which may be disposed on a user-facing portion of the watch body 2120 and/or the wearable band 2110). In some embodiments, the sensors 2121 include one or more capacitive sensors 2166. In some embodiments, the sensors 2121 include one or more heart rate sensors 2167. In some embodiments, the sensors 2121 include one or more IMUs 2168. In some embodiments, one or more IMUs 2168 can be configured to detect movement of a user's hand or other location that the watch body 2120 is placed or held.

In some embodiments, the peripherals interface 2161 includes an NFC component 2169, a GPS component 2170, a long-term evolution (LTE) component 2171, and/or a Wi-Fi and/or Bluetooth communication component 2172. In some embodiments, the peripherals interface 2161 includes one or more buttons 2173 (e.g., the peripheral buttons 2123 and 2127 in FIG. 21A), which, when selected by a user, cause operations to be performed at the watch body 2120. In some embodiments, the peripherals interface 2161 includes one or more indicators, such as a light-emitting diode (LED), to provide a user with visual indicators (e.g., message received, low battery, an active microphone, and/or a camera).

The watch body 2120 can include at least one display 2105 for displaying visual representations of information or data to the user, including user-interface elements and/or three-dimensional (3D) virtual objects. The display can also include a touch screen for inputting user inputs, such as touch gestures, swipe gestures, and the like. The watch body 2120 can include at least one speaker 2174 and at least one microphone 2175 for providing audio signals to the user and receiving audio input from the user. The user can provide user inputs through the microphone 2175 and can also receive audio output from the speaker 2174 as part of a haptic event provided by the haptic controller 2178. The watch body 2120 can include at least one camera 2125, including a front-facing camera 2125a and a rear-facing camera 2125b. The cameras 2125 can include ultra-wide-angle cameras, wide-angle cameras, fish-eye cameras, spherical cameras, telephoto cameras, depth-sensing cameras, or other types of cameras.

The watch body computing system 2160 can include one or more haptic controllers 2178 and associated componentry (e.g., haptic devices 2176) for providing haptic events at the watch body 2120 (e.g., a vibrating sensation or audio output in response to an event at the watch body 2120). The haptic controllers 2178 can communicate with one or more haptic devices 2176, such as electroacoustic devices, including a speaker of the one or more speakers 2174 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 2178 can provide haptic events to respective haptic actuators that are capable of being sensed by a user of the watch body 2120. In some embodiments, the one or more haptic controllers 2178 can receive input signals from an application of the applications 2182.

In some embodiments, the computer system 2130 and/or the computer system 2160 can include memory 2180, which can be controlled by a memory controller of the one or more controllers 2177 and/or one or more processors 2179. In some embodiments, software components stored in the memory 2180 include one or more applications 2182 configured to perform operations at the watch body 2120. In some embodiments, the one or more applications 2182 include games, word processors, messaging applications, calling applications, web browsers, social media applications, media streaming applications, financial applications, calendars, clocks, etc. In some embodiments, software components stored in the memory 2180 include one or more communication interface modules 2183 as defined above. In some embodiments, software components stored in the memory 2180 include one or more graphics modules 2184 for rendering, encoding, and/or decoding audio and/or visual data; and one or more data management modules 2185 for collecting, organizing, and/or providing access to the data 2187 stored in memory 2180. In some embodiments, software components stored in the memory 2180 include a feedback module 2186A, which is configured to perform the features described above in reference to FIGS. 1-21. In some embodiments, one or more of applications 2182 and/or one or more modules can work in conjunction with one another to perform various tasks at the watch body 2120.

In some embodiments, software components stored in the memory 2180 can include one or more operating systems 2181 (e.g., a Linux-based operating system, an Android operating system, etc.). The memory 2180 can also include data 2187. The data 2187 can include profile data 2188A, sensor data 2189A, media content data 2190, application data 2191, and feedback specific data 2192A, which stores data related to the performance of the features described above in reference to FIGS. 1-21.

It should be appreciated that the watch body computing system 2160 is an example of a computing system within the watch body 2120, and that the watch body 2120 can have more or fewer components than shown in the watch body computing system 2160, combine two or more components, and/or have a different configuration and/or arrangement of the components. The various components shown in watch body computing system 2160 are implemented in hardware, software, firmware, or a combination thereof, including one or more signal processing and/or application-specific integrated circuits.

Turning to the wearable band computing system 2130, one or more components that can be included in the wearable band 2110 are shown. The wearable band computing system 2130 can include more or fewer components than shown in the watch body computing system 2160, combine two or more components, and/or have a different configuration and/or arrangement of some or all of the components. In some embodiments, all, or a substantial portion of the components of the wearable band computing system 2130 are included in a single integrated circuit. Alternatively, in some embodiments, components of the wearable band computing system 2130 are included in a plurality of integrated circuits that are communicatively coupled. As described above, in some embodiments, the wearable band computing system 2130 is configured to couple (e.g., via a wired or wireless connection) with the watch body computing system 2160, which allows the computing systems to share components, distribute tasks, and/or perform other operations described herein (individually or as a single device).

The wearable band computing system 2130, similar to the watch body computing system 2160, can include one or more processors 2149, one or more controllers 2147 (including one or more haptics controller 2148), a peripherals interface 2131 that can include one or more sensors 2113 and other peripheral devices, power source (e.g., a power system 2156), and memory (e.g., a memory 2150) that includes an operating system (e.g., an operating system 2151), data (e.g., data 2154 including profile data 2188B, sensor data 2189B, feedback module 2192B, etc.), and one or more modules (e.g., a communications interface module 2152, a data management module 2153, a feedback module 2186B, etc.).

The one or more sensors 2113 can be analogous to sensors 2121 of the computer system 2160 in light of the definitions above. For example, sensors 2113 can include one or more coupling sensors 2132, one or more SpO2 sensors 2134, one or more EMG sensors 2135, one or more capacitive sensors 2136, one or more heart rate sensors 2137, and one or more IMU sensors 2138.

The peripherals interface 2131 can also include other components analogous to those included in the peripheral interface 2161 of the computer system 2160, including an NFC component 2139, a GPS component 2140, an LTE component 2141, a Wi-Fi and/or Bluetooth communication component 2142, and/or one or more haptic devices 2176 as described above in reference to peripherals interface 2161. In some embodiments, the peripherals interface 2131 includes one or more buttons 2143, a display 2133, a speaker 2144, a microphone 2145, and a camera 2155. In some embodiments, the peripherals interface 2131 includes one or more indicators, such as an LED.

It should be appreciated that the wearable band computing system 2130 is an example of a computing system within the wearable band 2110, and that the wearable band 2110 can have more or fewer components than shown in the wearable band computing system 2130, combine two or more components, and/or have a different configuration and/or arrangement of the components. The various components shown in wearable band computing system 2130 can be implemented in one or a combination of hardware, software, and firmware, including one or more signal processing and/or application-specific integrated circuits.

The wrist-wearable device 2000 with respect to FIG. 21A is an example of the wearable band 2110 and the watch body 2120 coupled, so the wrist-wearable device 2000 will be understood to include the components shown and described for the wearable band computing system 2130 and the watch body computing system 2160. In some embodiments, wrist-wearable device 2000 has a split architecture (e.g., a split mechanical architecture or a split electrical architecture) between the watch body 2120 and the wearable band 2110. In other words, all of the components shown in the wearable band computing system 2130 and the watch body computing system 2160 can be housed or otherwise disposed in a combined watch device 2000, or within individual components of the watch body 2120, wearable band 2110, and/or portions thereof (e.g., a coupling mechanism 2116 of the wearable band 2110).

The techniques described above can be used with any device for sensing neuromuscular signals, including the arm-wearable devices of FIG. 21A-21B, but could also be used with other types of wearable devices for sensing neuromuscular signals (such as body-wearable or head-wearable devices that might have neuromuscular sensors closer to the brain or spinal column).

In some embodiments, a wrist-wearable device 2000 can be used in conjunction with a head-wearable device described below (e.g., AR device 2100 and VR device 2210) and/or an HIPD 2200, and the wrist-wearable device 2000 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 2100 and VR device 2210.

### Example Head-Wearable Devices

FIGS. 22A, 22B-1, 22B-2, and 22C show example head-wearable devices, in accordance with some embodiments. Head-wearable devices can include, but are not limited to, AR devices 2100 (e.g., AR or smart eyewear devices, such as smart glasses, smart monocles, smart contacts, etc.), VR devices 2210 (e.g., VR headsets or head-mounted displays (HMDs)), or other ocularly coupled devices. The AR devices 2100 and the VR devices 2210 are instances of the head-wearable devices such as no screen or limited screen smart glasses or AR/VR headsets as described in reference to FIGS. 1-20 herein, such that the head-wearable device should be understood to have the features of the AR devices 2100 and/or the VR devices 2210 and vice versa. The AR devices 2100 and the VR devices 2210 can perform various functions and/or operations associated with navigating through user interfaces and selectively opening applications, as well as the functions and/or operations described above with reference to FIGS. 1, 3, 10 and 11.

In some embodiments, an AR system (e.g., FIGS. 20A-20D-2; AR systems 2000a-2000d) includes an AR device 2100 (as shown in FIG. 22A) and/or VR device 2210 (as shown in FIGS. 22B-1-B-2). In some embodiments, the AR device 2100 and the VR device 2210 can include one or more analogous components (e.g., components for presenting interactive AR environments, such as processors, memory, and/or presentation devices, including one or more displays and/or one or more waveguides), some of which are described in more detail with respect to FIG. 22C. The head-wearable devices can use display projectors (e.g., display projector assemblies 2207A and 2207B) and/or waveguides for projecting representations of data to a user. Some embodiments of head-wearable devices do not include displays.

FIG. 22A shows an example visual depiction of the AR device 2100 (e.g., which may also be described herein as augmented-reality glasses and/or smart glasses). The AR device 2100 can work in conjunction with additional electronic components that are not shown in FIGS. 22A, such as a wearable accessory device and/or an intermediary processing device, in electronic communication or otherwise configured to be used in conjunction with the AR device 2100. In some embodiments, the wearable accessory device and/or the intermediary processing device may be configured to couple with the AR device 2100 via a coupling mechanism in electronic communication with a coupling sensor 2224, where the coupling sensor 2224 can detect when an electronic device becomes physically or electronically coupled with the AR device 2100. In some embodiments, the AR device 2100 can be configured to couple to a housing (e.g., a portion of frame 2204 or temple arms 2205), which may include one or more additional coupling mechanisms configured to couple with additional accessory devices. The components shown in FIG. 22A can be implemented in hardware, software, firmware, or a combination thereof, including one or more signal-processing components and/or application-specific integrated circuits (ASICs).

The AR device 2100 includes mechanical glasses components, including a frame 2204 configured to hold one or more lenses (e.g., one or both lenses 2206-1 and 2206-2). One of ordinary skill in the art will appreciate that the AR device 2100 can include additional mechanical components, such as hinges configured to allow portions of the frame 2204 of the AR device 2100 to be folded and unfolded, a bridge configured to span the gap between the lenses 2206-1 and 2206-2 and rest on the user's nose, nose pads configured to rest on the bridge of the nose and provide support for the AR device 2100, earpieces configured to rest on the user's ears and provide additional support for the AR device 2100, temple arms 2205 configured to extend from the hinges to the earpieces of the AR device 2100, and the like. One of ordinary skill in the art will further appreciate that some examples of the AR device 2100 can include none of the mechanical components described herein. For example, smart contact lenses configured to present AR to users may not include any components of the AR device 2100.

The lenses 2206-1 and 2206-2 can be individual displays or display devices (e.g., a waveguide for projected representations). The lenses 2206-1 and 2206-2 may act together or independently to present an image or series of images to a user. In some embodiments, the lenses 2206-1 and 2206-2 can operate in conjunction with one or more display projector assemblies 2207A and 2207B to present image data to a user. While the AR device 2100 includes two displays, embodiments of this disclosure may be implemented in AR devices with a single near-eye display (NED) or more than two NEDs.

The AR device 2100 includes electronic components, many of which will be described in more detail below with respect to FIG. 22C. Some example electronic components are illustrated in FIG. 22A, including sensors 2223-1, 2223-2, 2223-3, 2223-4, 2223-5, and 2223-6, which can be distributed along a substantial portion of the frame 2204 of the AR device 2100. The distinct types of sensors are described below in reference to FIG. 22C. The AR device 2100 also includes a left camera 2239A and a right camera 2239B, which are located on different sides of the frame 2204. And the eyewear device includes one or more processors 2248A and 2248B (e.g., an integral microprocessor, such as an ASIC) that is embedded into a portion of the frame 2204.

FIGS. 22B-1 and 22B-2 show an example visual depiction of the VR device 2210 (e.g., a head-mounted display (HMD) 2212, also referred to herein as an AR headset, a head-wearable device, or a VR headset). The HMD 2212 includes a front body 2214 and a frame 2216 (e.g., a strap or band) shaped to fit around a user's head. In some embodiments, the front body 2214 and/or the frame 2216 includes one or more electronic elements for facilitating presentation of and/or interactions with an AR and/or VR system (e.g., displays, processors (e.g., processor 2248A-1), IMUs, tracking emitters or detectors, or sensors). In some embodiments, the HMD 2212 includes output audio transducers (e.g., an audio transducer 2218-1), as shown in FIG. 22B-2. In some embodiments, one or more components, such as the output audio transducer(s) 2218 and the frame 2216, can be configured to attach and detach (e.g., are detachably attachable) to the HMD 2212 (e.g., a portion or all of the frame 2216 and/or the output audio transducer 2218), as shown in FIG. 22B-2. In some embodiments, coupling a detachable component to the HMD 2212 causes the detachable component to come into electronic communication with the HMD 2212. The VR device 2210 includes electronic components, many of which will be described in more detail below with respect to FIG. 22C.

FIGS. 22B-1 and 22B-2 also show that the VR device 2210 having one or more cameras, such as the left camera 2239A and the right camera 2239B, which can be analogous to the left and right cameras on the frame 2204 of the AR device 2100. In some embodiments, the VR device 2210 includes one or more additional cameras (e.g., cameras 2239C and 2239D), which can be configured to augment image data obtained by the cameras 2239A and 2239B by providing more information. For example, the camera 2239C can be used to supply color information that is not discerned by cameras 2239A and 2239B. In some embodiments, one or more of the cameras 2239A to 2239D can include an optional IR (infrared) cut filter configured to remove IR light from being received at the respective camera sensors.

The VR device 2210 can include a housing 2290 storing one or more components of the VR device 2210 and/or additional components of the VR device 2210. The housing 2290 can be a modular electronic device configured to couple with the VR device 2210 (or an AR device 2100) and supplement and/or extend the capabilities of the VR device 2210 (or an AR device 2100). For example, the housing 2290 can include additional sensors, cameras, power sources, and processors (e.g., processor 2248A-2). to improve and/or increase the functionality of the VR device 2210. Examples of the different components included in the housing 2290 are described below in reference to FIG. 22C.

Alternatively, or in addition, in some embodiments, the head-wearable device, such as the VR device 2210 and/or the AR device 2100, includes, or is communicatively coupled to, another external device (e.g., a paired device), such as an HIPD 22 (discussed below in reference to FIGS. 22A-22B) and/or an optional neckband. The optional neckband can couple to the head-wearable device via one or more connectors (e.g., wired, or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device 2200, an optional neckband, and/or a wearable accessory device) with the head-wearable devices (e.g., an AR device 2100 and/or a VR device 2210) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 2200) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 2200, can process information generated by one or more of its sensors and/or information provided by other communicatively coupled devices. For example, a head-wearable device can include an IMU, and the intermediary processing device (a neckband and/or an HIPD 2200) can compute all inertial and spatial calculations from the IMUs located on the head-wearable device. Additional examples of processing performed by a communicatively coupled device, such as the HIPD 2200, are provided below in reference to FIGS. 22A and 22B.

AR systems may include a variety of types of visual feedback mechanisms. For example, display devices in the AR devices 2100 and/or the VR devices 2210 may include one or more liquid-crystal displays (LCDs), light emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 2100 and/or the VR device 2210 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 2100 and the VR device 2210, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 2100 and/or the VR device 2210 can include haptic feedback systems. The haptic feedback systems may provide several types of cutaneous feedback, including vibration, force, traction, shear, texture, and/or temperature. The haptic feedback systems may also provide distinct types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 2000, an HIPD 2200, and/or other devices described herein.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15%-50% of the ambient light and/or the real-world live view) can be passed through the user interface element, such that the user can distinguish at least a portion of the physical environment over which the user interface element is being displayed.

The head-wearable devices can include one or more external displays 2235A for presenting information to users. For example, an external display 2235A can be used to show a current battery level, network activity (e.g., connected, disconnected), current activity (e.g., playing a game, in a call, in a meeting, or watching a movie), and/or other relevant information. In some embodiments, the external displays 2235A can be used to communicate with others. For example, a user of the head-wearable device can cause the external displays 2235A to present a “do not disturb” notification. The external displays 2235A can also be used by the user to share any information captured by the one or more components of the peripherals interface 2222A and/or generated by the head-wearable device (e.g., during operation and/or performance of one or more applications).

The memory 2250A can include instructions and/or data executable by one or more processors 2248A (and/or processors 2248B of the housing 2290) and/or a memory controller of the one or more controllers 2246A (and/or controller 2246B of the housing 2290). The memory 2250A can include one or more operating systems 2251, one or more applications 2252, one or more communication interface modules 2253A, one or more graphics modules 2254A, one or more AR processing modules 2255A, feedback module 2256A which includes instructions and/or data configured to provide the user with haptic and audio feedback, and/or any other types of modules or components defined above or described with respect to any other embodiments discussed herein.

The data 2260 stored in memory 2250A can be used in conjunction with one or more of the applications and/or programs discussed above. The data 2260 can include profile data 2261, sensor data 2262, media content data 2263, AR application data 2264, feedback data 2265 including data for mapping lighting, pitch, intensity, and size, and/or any other types of data defined above or described with respect to any other embodiments discussed herein.

In some embodiments, the controller 2246A of the head-wearable devices processes information generated by the sensors 2223A on the head-wearable devices and/or another component of the head-wearable devices and/or communicatively coupled with the head-wearable devices (e.g., components of the housing 2290, such as components of peripherals interface 2222B). For example, the controller 2246A can process information from the acoustic sensors 2225 and/or image sensors 2226. For each detected sound, the controller 2246A can perform a direction of arrival (DOA) estimation to estimate a direction from which the detected sound arrived at a head-wearable device. As one or more of the acoustic sensors 2225 detect sounds, the controller 2246A can populate an audio data set with the information (e.g., represented by sensor data 2262).

In some embodiments, a physical electronic connector can convey information between the head-wearable devices and another electronic device, and/or between one or more processors 2248A of the head-wearable devices and the controller 2246A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 2200) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include distinct types of computer vision components and subsystems. For example, the AR device 2100 and/or the VR device 2210 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 22B-1 and 22B-2 show the VR device 2210 having cameras 2239A-2239D, which can be used to provide depth information for creating a voxel field and a 2D mesh to provide object information to the user to avoid collisions.

The optional housing 2290 can include analogous components to those describe above with respect to the computing system 2220. For example, the optional housing 2290 can include a respective peripherals interface 2222B, including more or fewer components to those described above with respect to the peripherals interface 2222A. As described above, the components of the optional housing 2290 can be used to augment and/or expand on the functionality of the head-wearable devices. For example, the optional housing 2290 can include respective sensors 2223B, speakers 2236B, displays 2235B, microphones 2237B, cameras 2238B, and/or other components to capture and/or present data. Similarly, the optional housing 2290 can include one or more processors 2248B, controllers 2246B, and/or memory 2250B (including respective communication interface modules 2253B, one or more graphics modules 2254B, one or more AR processing modules 2255B) that can be used individually and/or in conjunction with the components of the computing system 2220.

The techniques described above in FIGS. 22A-22C can be used with different head-wearable devices. In some embodiments, the head-wearable devices (e.g., the AR device 2100 and/or the VR device 2210) can be used in conjunction with one or more wearable devices such as a wrist-wearable device 2000 (or components thereof). Having thus described example the head-wearable devices, attention will now be turned to example handheld intermediary processing devices, such as HIPD 2200.

### Example Handheld Intermediary Processing Devices

FIGS. 23A and 23B illustrate an example handheld intermediary processing device (HIPD) 2200, in accordance with some embodiments. The HIPD 2200 is an instance of the handheld controllers held by the user described in reference to FIG. 3 herein, such that the HIPD 2200 should be understood to have the features described with respect to any intermediary device defined above or otherwise described herein, and vice versa. The HIPD 2200 can perform various functions and/or operations associated with navigating through user interfaces and selectively opening applications, as well as the functions and/or operations described above with reference to FIG. 3.

FIG. 23A shows a top view 2305 and a side view 2325 of the HIPD 2200. The HIPD 2200 is configured to communicatively couple with one or more wearable devices (or other electronic devices) associated with a user. For example, the HIPD 2200 is configured to communicatively couple with a user's wrist-wearable device 2000 (or components thereof, such as the watch body 2120 and the wearable band 2010), AR device 2100, and/or VR device 2210. The HIPD 2200 can be configured to be held by a user (e.g., as a handheld controller), carried on the user's person (e.g., in their pocket or in their bag), placed in proximity of the user (e.g., placed on their desk while seated at their desk or on a charging dock), and/or placed at or within a predetermined distance from a wearable device or other electronic device (e.g., where, in some embodiments, the predetermined distance is the maximum distance (e.g., 10 meters) at which the HIPD 2200 can successfully be communicatively coupled with an electronic device, such as a wearable device).

The HIPD 2200 can perform various functions independently and/or in conjunction with one or more wearable devices (e.g., wrist-wearable device 2000, AR device 2100, and/or VR device 2210). The HIPD 2200 is configured to increase and/or improve the functionality of communicatively coupled devices, such as the wearable devices. The HIPD 2200 is configured to perform one or more functions or operations associated with interacting with user interfaces and applications of communicatively coupled devices, interacting with an AR environment, interacting with a VR environment, and/or operating as a human-machine interface controller, as well as functions and/or operations described above with reference to FIG. 3. Additionally, as will be described in more detail below, functionality and/or operations of the HIPD 2200 can include, without limitation, task offloading and/or handoffs, thermals offloading and/or handoffs, 6 degrees of freedom (6DoF) ray casting and/or gaming (e.g., using imaging devices or cameras 2314A and 2314B, which can be used for simultaneous localization and mapping (SLAM), and/or with other image processing techniques), portable charging; messaging, image capturing via one or more imaging devices or cameras (e.g., cameras 2322A and 2322B), sensing user input (e.g., sensing a touch on a multitouch input surface 2302), wireless communications and/or interlining (e.g., cellular, near field, Wi-Fi, or personal area network), location determination, financial transactions, providing haptic feedback, alarms, notifications, biometric authentication, health monitoring, sleep monitoring. The above-example functions can be executed independently in the HIPD 2200 and/or in communication between the HIPD 2200 and another wearable device described herein. In some embodiments, functions can be executed on the HIPD 2200 in conjunction with an AR environment. As the skilled artisan will appreciate upon reading the descriptions provided herein, the novel HIPD 2200 described herein can be used with any type of suitable AR environment.

While the HIPD 2200 is communicatively coupled with a wearable device and/or other electronic device, the HIPD 2200 is configured to perform one or more operations initiated at the wearable device and/or the other electronic device. In particular, one or more operations of the wearable device and/or the other electronic device can be offloaded to the HIPD 2200 to be performed. The HIPD 2200 performs one or more operations of the wearable device and/or the other electronic device and provides data corresponding to the completed operations to the wearable device and/or the other electronic device. For example, a user can initiate a video stream using the AR device 2100 and back-end tasks associated with performing the video stream (e.g., video rendering) can be offloaded to the HIPD 2200, which the HIPD 2200 performs and provides corresponding data to the AR device 2100 to perform remaining front-end tasks associated with the video stream (e.g., presenting the rendered video data via a display of the AR device 2100). In this way, the HIPD 2200, which has more computational resources and greater thermal headroom than a wearable device can perform computationally intensive tasks for the wearable device, improving performance of an operation performed by the wearable device.

The HIPD 2200 includes a multi-touch input surface 2302 on a first side (e.g., a front surface) that is configured to detect one or more user inputs. In particular, the multi-touch input surface 2302 can detect single-tap inputs, multi-tap inputs, swipe gestures and/or inputs, force-based and/or pressure-based touch inputs, held taps, and the like. The multi-touch input surface 2302 is configured to detect capacitive touch inputs and/or force (and/or pressure) touch inputs. The multi-touch input surface 2302 includes a first touch-input surface 2304 defined by a surface depression, and a second touch-input surface 2306 defined by a substantially planar portion. The first touch-input surface 2304 can be disposed adjacent to the second touch-input surface 2306. In some embodiments, the first touch-input surface 2304 and the second touch-input surface 2306 can be different dimensions, shapes, and/or cover different portions of the multi-touch input surface 2302. For example, the first touch-input surface 2304 can be substantially circular and the second touch-input surface 2306 is substantially rectangular. In some embodiments, the surface depression of the multi-touch input surface 2302 is configured to guide user handling of the HIPD 2200. In particular, the surface depression is configured such that the user holds the HIPD 2200 upright when held in a single hand (e.g., such that the using imaging devices or cameras 2314A and 2314B are pointed toward a ceiling or the sky). Additionally, the surface depression is configured such that the user's thumb rests within the first touch-input surface 2304.

In some embodiments, the different touch-input surfaces include a plurality of touch-input zones. For example, the second touch-input surface 2306 includes at least a first touch-input zone 2308 within a second touch-input zone 2306 and a third touch-input zone 2310 within the first touch-input zone 2308. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 2308 causes the HIPD 2200 to perform a first command and a user input detected within the second touch-input zone 2306 causes the HIPD 2200 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 2308 can be configured to detect force touch inputs (e.g., a magnitude at which the user presses down) and capacitive touch inputs, and the second touch-input zone 2306 can be configured to detect capacitive touch inputs.

The HIPD 2200 includes one or more sensors 2351 for sensing data used in the performance of one or more operations and/or functions. For example, the HIPD 2200 can include an IMU that is used in conjunction with cameras 2314 for 3-dimensional object manipulation (e.g., enlarging, moving, destroying, etc. an object) in an AR or VR environment. Non-limiting examples of the sensors 2351 included in the HIPD 2200 include a light sensor, a magnetometer, a depth sensor, a pressure sensor, and a force sensor. Additional examples of the sensors 2351 are provided below in reference to FIG. 23B.

The HIPD 2200 can include one or more light indicators 2312 to provide one or more notifications to the user. In some embodiments, the light indicators are LEDs or other types of illumination devices. The light indicators 2312 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 2304. The light indicators can be illuminated in distinct colors and/or patterns to provide the user with one or more notifications and/or information about the device. For example, a light indicator positioned around the first touch-input surface 2304 can flash when the user receives a notification (e.g., a message), change red when the HIPD 2200 is out of power, operate as a progress bar (e.g., a light ring that is closed when a task is completed (e.g., 0% to 100%)), operates as a volume indicator, etc.).

In some embodiments, the HIPD 2200 includes one or more additional sensors on another surface. For example, as shown FIG. 23A, HIPD 2200 includes a set of one or more sensors (e.g., sensor set 2320) on an edge of the HIPD 2200. The sensor set 2320, when positioned on an edge of the of the HIPD 2200, can be pe positioned at a predetermined tilt angle (e.g., 26 degrees), which allows the sensor set 2320 to be angled toward the user when placed on a desk or other flat surface. Alternatively, in some embodiments, the sensor set 2320 is positioned on a surface opposite the multi-touch input surface 2302 (e.g., a back surface). The one or more sensors of the sensor set 2320 are discussed in detail below.

The side view 2325 of the of the HIPD 2200 shows the sensor set 2320 and camera 2314B. The sensor set 2320 includes one or more cameras 2323A and 2323B, a depth projector 2324, an ambient light sensor 2328, and a depth receiver 2330. In some embodiments, the sensor set 2320 includes a light indicator 2326. The light indicator 2326 can operate as a privacy indicator to let the user and/or those around them know that a camera and/or microphone is active. The sensor set 2320 is configured to capture a user's facial expression such that the user can puppet a custom avatar (e.g., showing emotions, such as smiles, laughter, etc., on the avatar or a digital representation of the user). The sensor set 2320 can be configured as a side stereo red-green-blue (RGB) system, a rear indirect time-of-flight (iToF) system, or a rear stereo RGB system. As the skilled artisan will appreciate upon reading the descriptions provided herein, the novel HIPD 2200 described herein can use different sensor set 2320 configurations and/or sensor set 2320 placement.

In some embodiments, the HIPD 2200 includes one or more haptic devices 2371 (FIG. 23B; e.g., a vibratory haptic actuator) that are configured to provide haptic feedback (e.g., kinesthetic sensation). The sensors 2351, and/or the haptic devices 2371 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 2200 is configured to operate without a display. However, in optional embodiments, the HIPD 2200 can include a display 2368 (FIG. 23B). The HIPD 2200 can also income one or more optional peripheral buttons 2367 (FIG. 23B). For example, the peripheral buttons 2367 can be used to turn on or turn off the HIPD 2200. Further, the HIPD 2200 housing can be formed of polymers and/or elastomer elastomers. The HIPD 2200 can be configured to have a non-slip surface to allow the HIPD 2200 to be placed on a surface without requiring a user to watch over the HIPD 2200. In other words, the HIPD 2200 is designed such that it would not easily slide off a surface. In some embodiments, the HIPD 2200 include one or magnets to couple the HIPD 2200 to another surface. This allows the user to mount the HIPD 2200 to different surfaces and provide the user with greater flexibility in use of the HIPD 2200.

As described above, the HIPD 2200 can distribute and/or provide instructions for performing the one or more tasks at the HIPD 2200 and/or a communicatively coupled device. For example, the HIPD 2200 can identify one or more back-end tasks to be performed by the HIPD 2200 and one or more front-end tasks to be performed by a communicatively coupled device. While the HIPD 2200 is configured to offload and/or handoff tasks of a communicatively coupled device, the HIPD 2200 can perform both back-end and front-end tasks (e.g., via one or more processors, such as CPU 2377; FIG. 23B). The HIPD 2200 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 2200 can perform the above operations alone or in conjunction with a wearable device (or other communicatively coupled electronic device).

FIG. 23B shows block diagrams of a computing system 2340 of the HIPD 2200, in accordance with some embodiments. The HIPD 2200, described in detail above, can include one or more components shown in HIPD computing system 2340. The HIPD 2200 will be understood to include the components shown and described below for the HIPD computing system 2340. In some embodiments, all, or a substantial portion of the components of the HIPD computing system 2340 are included in a single integrated circuit. Alternatively, in some embodiments, components of the HIPD computing system 2340 are included in a plurality of integrated circuits that are communicatively coupled.

The HIPD computing system 2340 can include a processor (e.g., a CPU 2377, a GPU, and/or a CPU with integrated graphics), a controller 2375, a peripherals interface 2350 that includes one or more sensors 2351 and other peripheral devices, a power source (e.g., a power system 2395), and memory (e.g., a memory 2378) that includes an operating system (e.g., an operating system 2379), data (e.g., data 2388), one or more applications (e.g., applications 2380), and one or more modules (e.g., a communications interface module 2381, a graphics module 2382, a task and processing management module 2383, an interoperability module 2384, an AR processing module 2385, a data management module 2386, a feedback module 2387, etc.). The HIPD computing system 2340 further includes a power system 2395 that includes a charger input and output 2396, a PMIC 2397, and a battery 2398, all of which are defined above.

In some embodiments, the peripherals interface 2350 can include one or more sensors 2351. The sensors 2351 can include analogous sensors to those described above in reference to FIG. 20B. For example, the sensors 2351 can include imaging sensors 2354, (optional) EMG sensors 2356, IMUs 2358, and capacitive sensors 2360. In some embodiments, the sensors 2351 can include one or more pressure sensor 2352 for sensing pressure data, an altimeter 2353 for sensing an altitude of the HIPD 2200, a magnetometer 2355 for sensing a magnetic field, a depth sensor 2357 (or a time-of flight sensor) for determining a difference between the camera and the subject of an image, a position sensor 2359 (e.g., a flexible position sensor) for sensing a relative displacement or position change of a portion of the HIPD 2200, a force sensor 2361 for sensing a force applied to a portion of the HIPD 2200, and a light sensor 2362 (e.g., an ambient light sensor) for detecting an amount of lighting. The sensors 2351 can include one or more sensors not shown in FIG. 23B.

Analogous to the peripherals described above in reference to FIGS. 20B, the peripherals interface 2350 can also include an NFC component 2363, a GPS component 2364, an LTE component 2365, a Wi-Fi and/or Bluetooth communication component 2366, a speaker 2369, a haptic device 2371, and a microphone 2373. As described above in reference to FIG. 23A, the HIPD 2200 can optionally include a display 2368 and/or one or more buttons 2367. The peripherals interface 2350 can further include one or more cameras 2370, touch surfaces 2372, and/or one or more light emitters 2374. The multi-touch input surface 2302 described above in reference to FIG. 23A is an example of touch surface 2372. The light emitters 2374 can be one or more LEDs, lasers, etc. and can be used to project or present information to a user. For example, the light emitters 2374 can include light indicators 2312 and 2326 described above in reference to FIG. 23A. The cameras 2370 (e.g., cameras 2314A, 2314B, and 2323 described above in FIG. 23A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 2370 can be used for SLAM; 6 DoF ray casting, gaming, object manipulation, and/or other rendering; facial recognition and facial expression recognition, etc.

Similar to the watch body computing system 2060 and the watch band computing system 2130 described above in reference to FIG. 20B, the HIPD computing system 2340 can include one or more haptic controllers 2376 and associated componentry (e.g., haptic devices 2371) for providing haptic events at the HIPD 2200.

Memory 2378 can include high-speed random-access memory and/or non-volatile memory, such as one or more magnetic disk storage devices, flash memory devices, or other non-volatile solid-state memory devices. Access to the memory 2378 by other components of the HIPD 2200, such as the one or more processors and the peripherals interface 2250, can be controlled by a memory controller of the controllers 2375.

In some embodiments, software components stored in the memory 2378 include one or more operating systems 2379, one or more applications 2380, one or more communication interface modules 2381, one or more graphics modules 2382, one or more data management modules 2385, which are analogous to the software components described above in reference to FIG. 20B. The software components stored in the memory 2378 can also include a feedback module 2387, which is configured to perform the features described above in reference to FIGS. 1-20.

In some embodiments, software components stored in the memory 2378 include a task and processing management module 2383 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 2383 uses data 2388 (e.g., device data 2390) to distribute the one or more front-end and/or back-end tasks based on communicatively coupled devices' computing resources, available power, thermal headroom, ongoing operations, and/or other factors. For example, the task and processing management module 2383 can cause the performance of one or more back-end tasks (of an operation performed at communicatively coupled AR device 2100) at the HIPD 2200 in accordance with a determination that the operation is utilizing a predetermined amount (e.g., at least 70%) of computing resources available at the AR device 2100.

In some embodiments, software components stored in the memory 2378 include an interoperability module 2384 for exchanging and utilizing information received and/or provided to distinct communicatively coupled devices. The interoperability module 2384 allows for different systems, devices, and/or applications to connect and communicate in a coordinated way without user input. In some embodiments, software components stored in the memory 2378 include an AR module 2385 that is configured to process signals based at least on sensor data for use in an AR and/or VR environment. For example, the AR processing module 2385 can be used for 3D object manipulation, gesture recognition, facial and facial expression, recognition, etc.

The memory 2378 can also include data 2387, including structured data. In some embodiments, the data 2387 can include profile data 2389, device data 2389 (including device data of one or more devices communicatively coupled with the HIPD 2200, such as device type, hardware, software, configurations, etc.), sensor data 2391, media content data 2392, application data 2393, and feedback data 2394, which stores data related to the performance of the features described above in reference to FIGS. 1-20.

It should be appreciated that the HIPD computing system 2340 is an example of a computing system within the HIPD 2200, and that the HIPD 2200 can have more or fewer components than shown in the HIPD computing system 2340, combine two or more components, and/or have a different configuration and/or arrangement of the components. The various components shown in HIPD computing system 2340 are implemented in hardware, software, firmware, or a combination thereof, including one or more signal processing and/or application-specific integrated circuits.

The techniques described above in FIG. 23A-23B can be used with any device used as a human-machine interface controller. In some embodiments, an HIPD 2200 can be used in conjunction with one or more wearable device such as a head-wearable device (e.g., AR device 2100 and VR device 2210) and/or a wrist-wearable device 2000 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium including instructions that, when executed by a computing device, cause the computing device to:
while a user is wearing an extended-reality headset that is associated with an output device:
at a first point in time, in accordance with a determination that a focus selector for the extended-reality headset is directed to a first object with first visual characteristics, provide first haptic feedback and first audio feedback corresponding to the first visual characteristics via the output device; and
at a second point in time that is after the first point in time, in accordance with a determination that the focus selector for the extended-reality headset is directed to a second object with second visual characteristics, distinct from the first visual characteristics, provide second haptic feedback and second audio feedback, distinct from the first haptic feedback and the first audio feedback, respectively, corresponding to the second visual characteristics via the output device.

2. The non-transitory computer-readable storage medium of claim 1, further comprising instructions for causing the computer device to:
at a third point in time that is after the first point in time and after the second point in time, in accordance with a determination that the focus selector for the extended-reality headset is directed to a third object with third visual characteristics, distinct from the first and second visual characteristics, provide third haptic feedback and third audio feedback, the third haptic feedback being distinct from the first and second haptic feedback and the third audio feedback being distinct from the first and second audio feedback, corresponding to the third visual characteristics via the output device.

3. The non-transitory computer-readable storage medium of claim 1, wherein:
the first and second visual characteristics include object material, object position, object color lightness, and object size,
each of the first and second audio feedback is provided using respective values for includes audio timbre, audio direction, and audio pitch, and
each of the first and second haptic feedback is provided using respective values for haptic intensity,
wherein respective values for audio timbre are selected based on object material, respective values for audio direction are selected based on object position, respective values for audio pitch are selected based on object color lightness, and respective values for haptic intensity are selected based on object size.

4. The non-transitory computer-readable storage medium of claim 1, wherein the focus selector is a gaze-based cursor.

5. The non-transitory computer-readable storage medium of claim 1, wherein the output device is one of: a wrist-wearable device, a head-wearable device, or a wearable glove.

6. The non-transitory computer-readable storage medium of claim 1, wherein the extended-reality headset does not include a display.

7. The non-transitory computer-readable storage medium of claim 1, wherein the first haptic feedback and the first audio feedback are provided by different devices.

8. A method, comprising:
while a user is wearing an extended-reality headset that is associated with an output device:
at a first point in time, in accordance with a determination that a focus selector for the extended-reality headset is directed to a first object with first visual characteristics, providing first haptic feedback and first audio feedback corresponding to the first visual characteristics via the output device; and
at a second point in time that is after the first point in time, in accordance with a determination that the focus selector for the extended-reality headset is directed to a second object with second visual characteristics, distinct from the first visual characteristics, providing second haptic feedback and second audio feedback, distinct from the first haptic feedback and the first audio feedback, respectively, corresponding to the second visual characteristics via the output device.

9. The method of claim 8, further comprising:
at a third point in time that is after the first point in time and after the second point in time, in accordance with a determination that the focus selector for the extended-reality headset is directed to a third object with third visual characteristics, distinct from the first and second visual characteristics, providing third haptic feedback and third audio feedback, the third haptic feedback being distinct from the first and second haptic feedback and the third audio feedback being distinct from the first and second audio feedback, corresponding to the third visual characteristics via the output device.

10. The method of claim 8, wherein:
the first and second visual characteristics include object material, object position, object color lightness, and object size,
each of the first and second audio feedback is provided using respective values for includes audio timbre, audio direction, and audio pitch, and
each of the first and second haptic feedback is provided using respective values for haptic intensity,
wherein respective values for audio timbre are selected based on object material, respective values for audio direction are selected based on object position, respective values for audio pitch are selected based on object color lightness, and respective values for haptic intensity are selected based on object size.

11. The method of claim 8, wherein the focus selector is a gaze-based cursor.

12. The method of claim 8, wherein the output device is one of: a wrist-wearable device, a head-wearable device, or a wearable glove.

13. The method of claim 8, wherein the extended-reality headset does not include a display.

14. The method of claim 8, wherein the first haptic feedback and the first audio feedback are provided by different devices.

15. A system that includes an extended-reality headset that is associated with an output device, and the extended-reality headset is configured to perform operations including:
while a user is wearing an extended-reality headset that is associated with an output device:
at a first point in time, in accordance with a determination that a focus selector for the extended-reality headset is directed to a first object with first visual characteristics, providing first haptic feedback and first audio feedback corresponding to the first visual characteristics via the output device; and
at a second point in time that is after the first point in time, in accordance with a determination that the focus selector for the extended-reality headset is directed to a second object with second visual characteristics, distinct from the first visual characteristics, providing second haptic feedback and second audio feedback, distinct from the first haptic feedback and the first audio feedback, respectively, corresponding to the second visual characteristics via the output device.

16. The system of claim 15, further comprising:
at a third point in time that is after the first point in time and after the second point in time, in accordance with a determination that the focus selector for the extended-reality headset is directed to a third object with third visual characteristics, distinct from the first and second visual characteristics, providing third haptic feedback and third audio feedback, the third haptic feedback being distinct from the first and second haptic feedback and the third audio feedback being distinct from the first and second audio feedback, corresponding to the third visual characteristics via the output device.

17. The system of claim 15, wherein:
the first and second visual characteristics include object material, object position, object color lightness, and object size,
each of the first and second audio feedback is provided using respective values for includes audio timbre, audio direction, and audio pitch, and
each of the first and second haptic feedback is provided using respective values for haptic intensity,
wherein respective values for audio timbre are selected based on object material, respective values for audio direction are selected based on object position, respective values for audio pitch are selected based on object color lightness, and respective values for haptic intensity are selected based on object size.

18. The system of claim 15, wherein the focus selector is a gaze-based cursor.

19. The system of claim 15, wherein the output device is one of: a wrist-wearable device, a head-wearable device, or a wearable glove.

20. The system of claim 15, wherein the extended-reality headset does not include a display.
